(19) United States
(12) Patent Application Publication
(10) Pub. No.: US 2018/0225673 A1
(43) Pub. Date: Aug. 9, 2018

(54) ELECTRONIC RECEIPT COLLECTION AND MANAGEMENT SYSTEM FOR REDEEMING CONSUMER PROTECTIONS

(71) Applicant: ShopInBox, Inc., Sunnyvale, CA (US)

(72) Inventors: Abhinav Dubey, Sunnyvale, CA (US); Janne Salminen, Los Gatos, CA (US)

(73) Assignee: ShopInBox, Inc., Sunnyvale, CA (US)

(21) Appl. No.: 15/890,268

(22) Filed: Feb. 6, 2018

Related U.S. Application Data
(60) Provisional application No. 62/455,528, filed on Feb. 6, 2017.

(51) Int. Cl. G06Q 30/00; G06Q 10/10; G06Q 40/08; G06Q 40/00

(52) U.S. Cl. CPC G06Q 30/012; G06Q 40/12; G06Q 40/08; G06Q 10/10

(57) ABSTRACT

Systems and methods are provided for redeeming consumer protections. A system retrieves item level purchase data for a purchase item from a user. Based on the item level purchase data for a purchase item, the system determines at least one policy that corresponds to the purchase item and determines if the item level purchase data satisfies at least one predetermined condition associated with the determined policy when the at least one policy corresponds to the purchase item. The system generates a claim form when the item level purchase data satisfies the at least one predetermined condition associated with the determined policy.

### BACKGROUND

Consumers often do not take advantage of consumer protections offered by financial institutions, such as credit card companies, because they are either unaware of the consumer protections, do not have the time to redeem the consumer protections, or forget to apply for the consumer protections within the allowed timeframe. For example, many financial institutions will lure consumers into obtaining credit cards by offering a variety of consumer protections, such as extended warranties on certain purchases. Although a consumer may purchase an item that is covered by the extended warranty offered by their credit card company, they may have forgotten that their credit card offered this protection. Thus, it is highly unlikely that the consumer will take advantage of the extended warranty protection.

Similarly, retailers may entice customers into buying items by providing a price guarantee knowing most customers will not take advantage of the price guarantee. Customers are generally unlikely to price shop after purchasing an item and are equally unlikely to redeem a price guarantee even if they found the item at a lower price due to the hassle involved in claiming the price guarantee. Some retailers make it extremely difficult for customers to claim benefit to the price guarantee by instituting policies or procedures that are hard to understand due to the legal ease used in writing the policy or by requiring the user fill out complicated forms.

For example, a credit card issuing company may offer a 60-day monitoring of items purchased with the credit card. Within the 60 days, if a price reduction of the item purchased is found, then the credit card issuing company will refund the difference between the price paid for the item and the lower price found. However, in order for the credit card issuing company to track or monitor a user's purchase, a user must first register the purchased item so that the purchased item can be associated with the user's account. To register the item, the user must first search for the item using the name, model number, description or UPC code. Once the user finds the item from a plethora of inventory items returned by the search, the user must upload a receipt and enter in product information, such as the price paid and the date purchased. Only then can the credit card issuing company commence a search of various sites to find a lower price for the purchased item within the 60 days of the purchase.

Although a user may receive the 60-day price protection guarantee from a credit card issuing company, the user must go through multiple tedious steps to register the item for monitoring and even then, many items that are purchased may not eligible for the price protection. For example, if a user purchases a sweater from a store that happens to be going out of business, the user would have to register the sweater by searching for the item using the name, model number, description or UPC code. The user must specific as possible, since the site has an enormous inventory. For example, typing “sweater” into the search box would yield more than 30,000 results. Then the user would have to manually enter purchase price, date purchased, and where the product was bought. After going through all this hassle, the user may find out that the purchase does not qualify because it was purchased from a store that was going out of business. To avoid these hassles, many users choose not take advantage of the price protection guarantee offered by the credit card issuing company.

Furthermore, such systems only cover single benefits (i.e. price protection) rather than all the benefits that are available (i.e. warranties and refunds). Currently, there is no automated way of determining purchases a user made without the user having to manually enter information associated with the purchases, tracking the identified purchases for price differentials amongst various online and brick-and-mortar stores, or claiming a plurality of consumer protections offered to the user based on the identified purchase and/or the payment method used to pay for the purchase. The systems that currently exist also do not provide a structured graphical user interfaces that can update a plurality of consumer protection available to the user in real-time based on the user's location or based on purchases the user is currently making.

What is needed is a system and method of automatically discovering, tracking and claiming multiple consumer protections that are applicable to a user based on the purchases of a user.

### BRIEF DESCRIPTION OF THE DRAWINGS

Advantages of the subject matter claimed will become apparent to those skilled in the art upon reading this description in conjunction with the accompanying drawings, in which like reference numerals have been used to designate like elements, and in which:

FIG. 1 illustrates a simplified block diagram of a distributed computer network in accordance with some embodiments of the invention.

FIG. 2 illustrates a system block diagram of a computer system, such as the client or server systems in accordance with some embodiments of the invention.

FIG. 3 illustrates a block diagram of a high-level view of an electronic receipts collection and management system for automatically redeeming consumer protections in accordance with an embodiment of the invention.

FIG. 4 illustrates a flow chart of a high-level exemplary method of redeeming consumer protections using the electronic receipts collection and management system in accordance with an embodiment of the invention.

FIG. 5 illustrates a flow chart of a granular level exemplary method of determining product detail data using electronic receipts collection and management system for redeeming consumer protections in accordance with an embodiment of the invention.

FIG. 6 illustrates a flow chart of a granular level exemplary method of determining if a purchased item qualifies for consumer protection using the electronic receipts collection and management system for redeeming consumer protections in accordance with an embodiment of the invention.

FIG. 7 illustrates a flow chart of a granular level exemplary method of determining if a purchased item qualifies for consumer protections using the electronic receipts collection and management system for redeeming consumer protections in accordance with another embodiment of the invention.

FIG. 8 illustrates a flow chart of a granular level exemplary method of determining if a purchased item qualifies for consumer protection using the electronic receipts collection and management system for redeeming consumer protections in accordance with another embodiment of the invention.

FIG. 9 illustrates a graphical user interface in accordance with an embodiment of the invention.

FIG. 10 illustrates another graphical user interface in accordance with an embodiment of the invention.

FIG. 11 illustrates another graphical user interface in accordance with an embodiment of the invention.

FIG. 12 illustrates another graphical user interface in accordance with an embodiment of the invention.

FIG. 13 illustrates another graphical user interface in accordance with an embodiment of the invention.

FIG. 14 illustrates a flow chart illustrating a method used to notify a user of updated travel information and travel benefits in accordance with an embodiment of the invention.

FIG. 15 illustrates another graphical user interface in accordance with an embodiment of the invention.

FIG. 16 illustrates another graphical user interface in accordance with an embodiment of the invention.

FIG. 17 illustrates another graphical user interface in accordance with an embodiment of the invention.

FIG. 18 illustrates another graphical user interface in accordance with an embodiment of the invention.

FIG. 19 illustrates another graphical user interface in accordance with an embodiment of the invention.

FIG. 20 illustrates another graphical user interface in accordance with an embodiment of the invention.

FIG. 21 illustrates another graphical user interface in accordance with an embodiment of the invention.

### DETAILED DESCRIPTION

The subject matter presented herein provides an electronic receipts collection and management system for redeeming consumer protections associated with purchases made by a user.

According to an embodiment, the electronic receipt collection and management system for redeeming consumer protections comprises a consumer protection platform that receives or retrieves item level purchase data associated with purchases made by the user. Using the item level purchase data, the system may determine at least one policy that corresponds to the purchased item. The policy, as used herein, refers to consumer protections or benefits offered by a user's credit card, a retailer, or any other financial institution, such as a price protection guarantee, extended warranty, return policies, and the like. The system makes a determination of whether the item level purchase data satisfies at least one predetermined condition associated with the determined policy. If the item level purchase data satisfies the predetermined condition, then a claim associated with the policy is generated for the user. In one embodiment, the claim may be automatically submitted to the financial institution or retailer associated with the policy. In another embodiment, the platform may provide information to the user and the user may use the information to generate a claim.

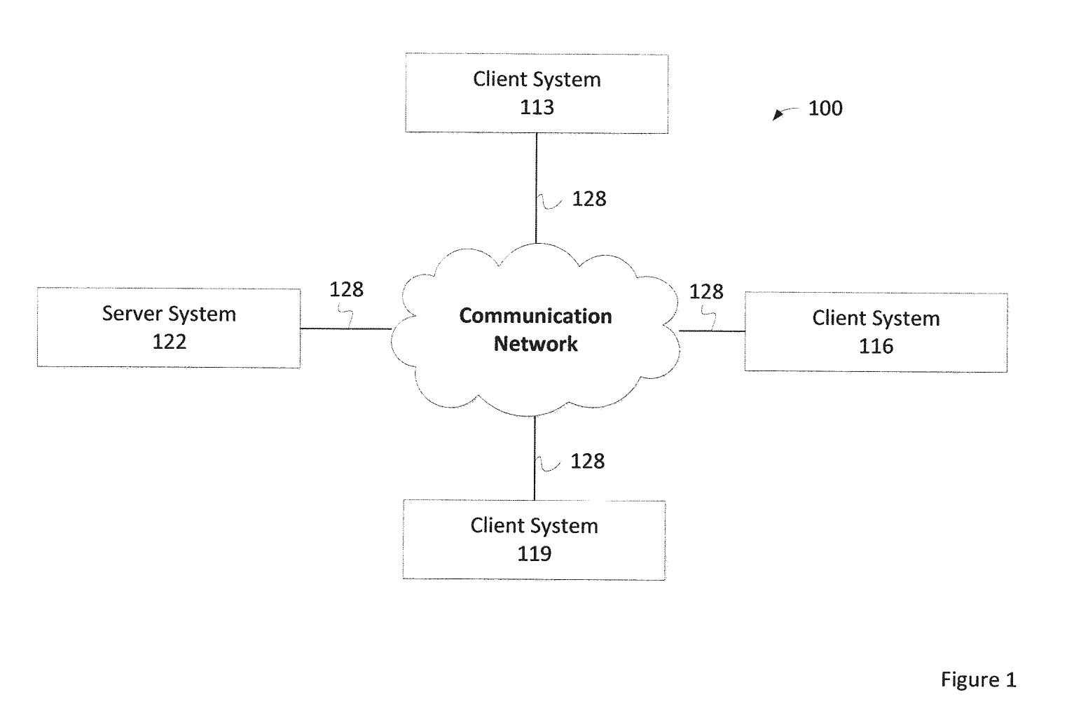

Prior to describing the subject matter in detail, an exemplary hardware device in which the subject matter may be implemented shall first be described. Those of ordinary skill in the art will appreciate that the elements illustrated in FIG. 1 may vary depending on the system implementation. FIG. 1 is a simplified block diagram of a distributed computer network 100. Computer network 100 includes a number of client systems 113, 116, and 119, and a server system 122 coupled to a communication network 124 via a plurality of communication links 128. There may be any number of clients and servers in a system. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment and is not intended to limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both a client and a server depending on whether the computer system is requesting or providing information. Additionally, although aspects of the invention have been described using a client-server environment, it should be apparent that the invention may also be embodied in a stand-alone computer system. Aspects of the invention may be embodied using a client-server environment or a cloud-computing environment.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, a “Web browser” application executing on a client system enables users to select, access, retrieve, or query information stored by server system 122. Examples of web browsers include the Internet Explorer browser program provided by Microsoft Corporation, and the Firefox browser provided by Mozilla Foundation, and others.

The client or server system may use a user interfaces with the system through a computer workstation system. The client or server system may include a monitor, screen, cabinet, keyboard, and mouse. Mouse may have one or more buttons such as mouse buttons. Cabinet houses familiar computer components, some of which are not shown, such as a processor, memory, mass storage devices, and the like.

Mass storage devices associated with the client or server may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented or computer-executable version of the invention may be embodied using, stored on, or associated with computer-readable medium or non-transitory computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device. The source code of the software may also be stored or reside on mass storage device (e.g., hard disk, magnetic disk, tape, or CD-ROM). As a further example, code may be transmitted via wires, radio waves, or through a network such as the Internet.

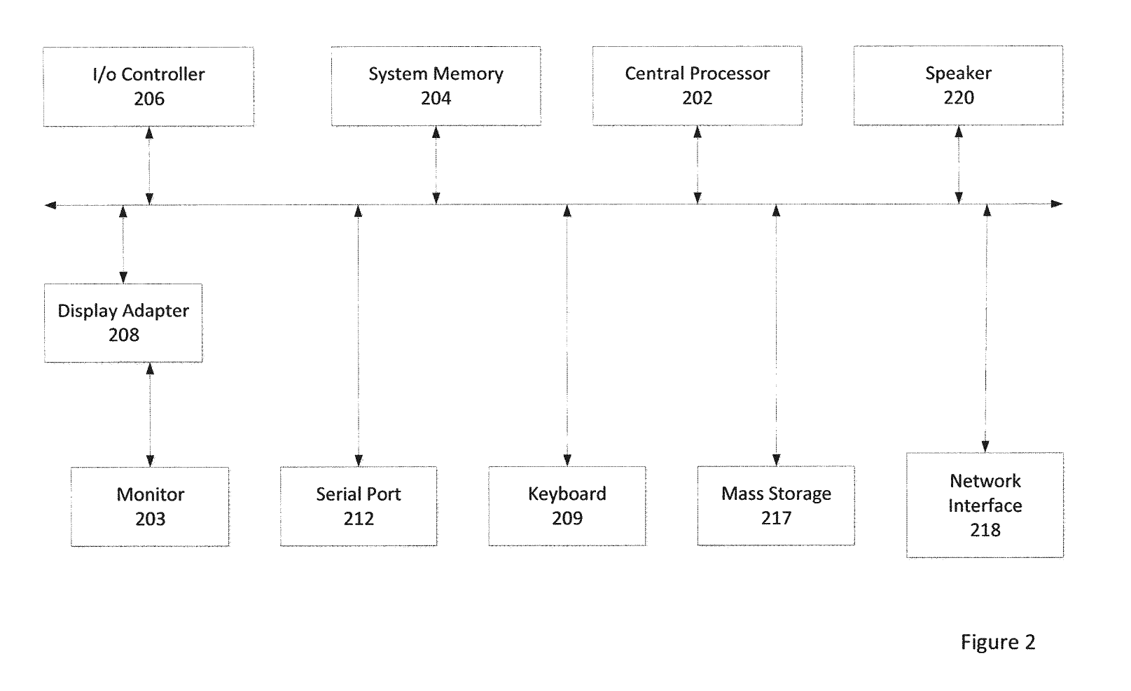

FIG. 2 shows a system block diagram of a computer system, such as the client or server systems. The computer system includes monitor 203, keyboard 209, and mass storage devices 217. Computer system 201 further includes subsystems such as central processor 202, system memory 204, input/output (I/O) controller 206, display adapter 208, serial or universal serial bus (USB) port 212, network interface 218, and speaker 220. In an embodiment, a computer system includes additional or fewer subsystems. For example, a computer system could include more than one processor 202 (i.e., a multiprocessor system) or a system may include a cache memory.

Arrows, as illustrated in FIG. 2, represent the system bus architecture of computer system 201. However, these arrows are illustrative of any interconnection scheme serving to link the subsystems. For example, speaker 220 could be connected to the other subsystems through a port or have an internal direct connection to central processor 302. The processor may include multiple processors or a multicore processor, which may permit parallel processing of information. Computer system 201 shown in FIG. 2 is but an example of a suitable computer system. Other configurations of subsystems suitable for use will be readily apparent to one of ordinary skill in the art.

Computer software products may be written in any of various suitable programming languages, such as C, C++, C#, Pascal, Fortran, Perl, Matlab (from MathWorks), SAS, SPSS, JavaScript, AJAX, Java, SQL, and XQuery (a query language that is designed to process data from XML files or any data source that can be viewed as XML, HTML, or both). The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation). In a specific embodiment, the present invention provides a computer program product which stores instructions such as computer code to program a computer to perform any of the processes or techniques described.

An operating system for the system may be one of the Microsoft Windows® family of operating systems (e.g., Windows 95, 98, Me, Windows NT, Windows 2000, Windows XP, Windows XP x64 Edition, Windows Vista, Windows 7, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

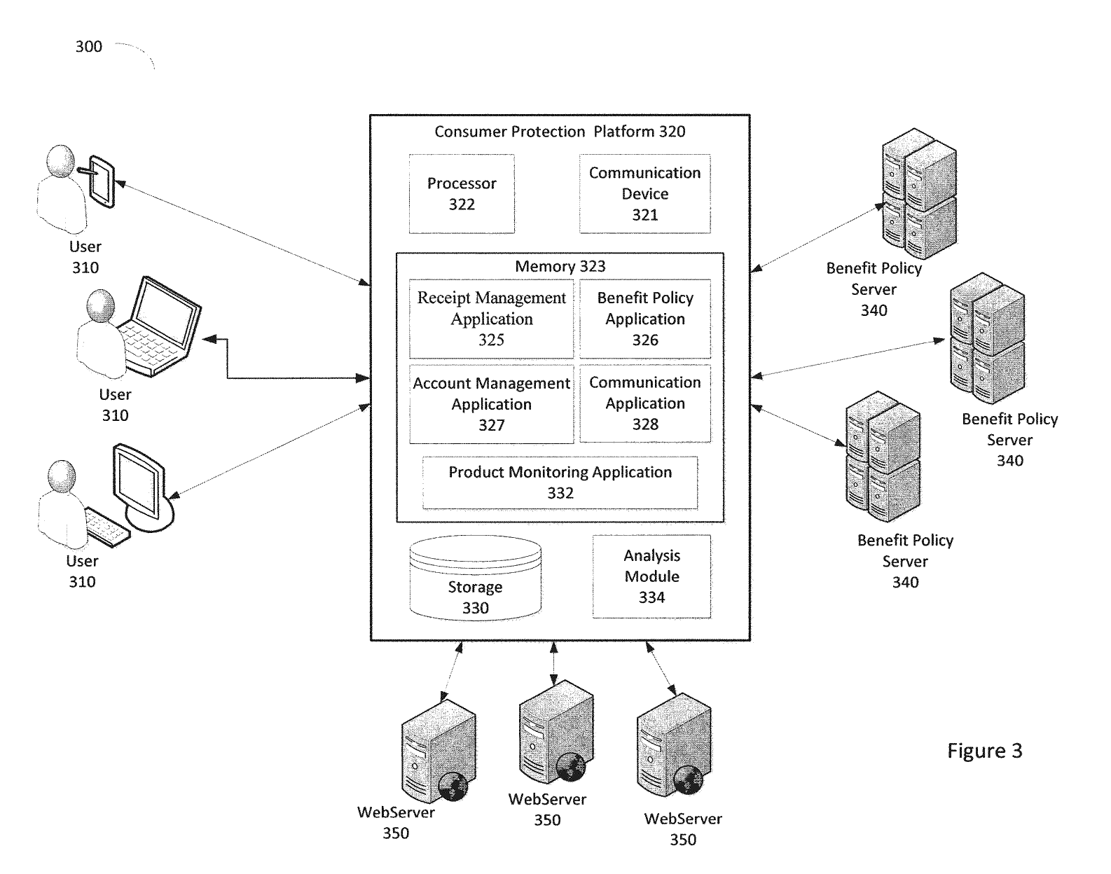

Referring now to FIG. 3, a block diagram of a high-level view of an electronic receipts collection and management system for redeeming consumer protections in accordance with an embodiment of the present invention. As shown in FIG. 3, in one embodiment, the electronic receipts collection and management system 300 includes a consumer protection platform 320 communicatively coupled to a plurality of users 310, web servers 350 and benefit policy servers 340. Although, for simplicity, FIG. 3 illustrates three users, it will be appreciated that, in some embodiments of the invention, there will be at least one user, one web server and one benefit policy server. Furthermore, although the term “benefit policy server” is used herein to describe some embodiments of the invention, other embodiments of the invention many involve servers associated with financial institutions that provide benefit and consumer protection information. As used herein and in the claims, the term “financial institution” refers to an institution that acts as an agent to provide financial services for its clients or members by processing financial transactions for its clients or members. Financial institutions can include, but are not limited to, banks, building societies, credit unions, stock brokerages, asset management firms, savings and loans, money lending companies, insurance brokerages, insurance underwriters, dealers in securities, and similar businesses. Retail, wholesale, and service businesses, as well as manufacturers, may also provide financial services by processing financial transactions and/or maintain accounts for consumers, as disclosed herein. As such, each of the benefit policy server 340 of FIG. 1 could be the computer system of different financial institution involved in banking or other financial transactions.

Referring again to the embodiment illustrated in FIG. 3, the users 310, web servers 350 and benefit platform servers 340 are operatively coupled, via a network, to the consumer protection platform 320. The network may be a global area network (GAN), such as the Internet, a wide area network (WAN), a local area network (LAN), or any other type of network or combination of networks. The network may provide for wire line, wireless, or a combination of wire line and wireless communication between devices in the network. In one embodiment, the network is a secure network. It will be understood that, when two components are described herein as communicating over a network, the components may be directly coupled to each other or indirectly coupled via one or more other components. Furthermore, although at least some of the systems described herein are described as having several unique components, these components need not be separate and distinct from one another, and two or more of such components may, in some embodiments, be combined into a single component that performs all of the functions of the multiple components so combined as described herein.

As illustrated in FIG. 3, the consumer protection platform 320 generally includes a communication device 321, a processor 322, and a memory device 323. The processor 322 is operatively coupled to the communication device 321 and the memory device 323. The processor 322 uses the communication device 321 to communicate with the users 310, the web servers 350, and the benefit policy servers 340 over the network.

The communication device 321 generally comprises a modem, server, wireless card, radio or other device for communicating with other devices on the network.

As further illustrated in FIG. 3, the consumer protection platform 320 includes computer-readable instructions stored in the memory device 323, which include the computer-readable instructions of a receipt management application 325, a benefit policy application 326, an account management application 327, an electronic communications application 328 and a product monitoring application 332. The receipts management application 325 includes computer program code that, when executed by the processing device 322, performs functions such as storing, organizing, and otherwise managing the electronic receipts and electronic copies of paper receipts belonging to the user 310. The benefit policy application 326 includes computer program code that, when executed by the processing device 322, performs functions such as storing, organizing, and otherwise managing a collection of benefit policies associated with various financial institutions, such as credit card companies or insurance companies 340.

The receipt management application 325 may monitor a user's e-mail accounts, financial institution accounts and the like to retrieve purchase information associated with purchases made by the user. Purchase information may include electronic receipts associated with purchased made by the user and/or transaction data associated with credit cards transactions used to make purchases by the user. The receipt management application 325 may also receive purchase information directly from the user. For example, the user may provide the consumer protection platform 320 an electronic copy of a receipt via uploading a copy of the electronic receipt, e-mailing a copy of the electronic receipt and the like. The user may also manually enter details of their purchase using a graphical user interface.

Using the received and retrieved purchase information, the receipt management application 325 may initiate the analysis module 334 to extract item level purchase data from the purchase information. Item level purchase data includes information about the items purchased, such as product name, price paid, retailer, UPC code, date of the purchase, and the like. If item level purchase data cannot be ascertained from the purchase information, the platform 320 may send an alert or notification to the user to provide such information. For example, if the receipt management application 325 retrieves a user's credit card statement (i.e. transactional data), the analysis module 334 may not be able to determine information related to the purchased item because the credit card statement merely includes the transaction amount, date/time of the transaction, and the retailer. The receipt management application 325 may send an alert or a notification to the user requesting the purchase information or item level purchase data associated with this transaction.

In one embodiment, the analysis module 334 may use match algorithms to match the item level purchase data associated with a purchased product to consumer protections that apply to the purchased products. Consumer protections may include benefits, rewards or policies offered by a financial institution, retailers, manufacturers and the like. Once matched, the analysis module 334 may return information regarding item level purchase data and/or the consumer protections associated with the item level purchase data to the account management application 327. The analysis module 334 may also determine whether the item level purchase data satisfies a condition associated with consumer protection prior to returning the information to the account management application 327. For example, the analysis module 34 may determine that a price guarantee from the retailer is associated with an item purchased by the user. The analysis module 334 may also determine that the time limit to claim the price guarantee has passed and the price guarantee is no longer applicable. Based on this determination, the analysis module will not forward information regarding the price guarantee to the account management application 327.

The account management application 327 may be an interactive web-based solution that may be accessed by account holders, including the users 310, to view their various accounts, including a receipts account, and perform account management tasks. In one embodiment, the account management application 327 may retrieve benefit policy information from benefit policy server 340 via the benefit policy application 236 and or the storage 330 which stores benefit policies of various financial institutions. The benefit policies, also referred to as benefits or policies, may include, but is not limited to, benefits or rewards offered by credit card companies and other financial institutions, policies or promotions offered by retailers, and consumer protections. The account management application 327 may allow a user to browse through the various benefits offered to the user by different credit card companies, financial institutions, retailers or other benefit policies applicable to the user. For example, if a user is interested in a certain purchase, the account management application 327 may recommend a certain credit card that has the best benefits to make the purchase with. Additionally, if the user has made a purchase, the account management application 327 may provide recommendations to additional purchases that user may be interested in and provide recommendations to a certain credit card that has the best benefits to use to make the new purchase. Optionally, the account management application 327 may provide a selectable option allowing the user to make the purchase at the time the recommendation is provided to the user.

In one embodiment, the account management application 327 may provide a user interface that displays a list of the products the user purchased along with benefits that are applicable for each of the purchases the user has made. In another embodiment, the account management application may provide a user interface that displays a list of the benefits that the user may take advantage based on financial institutions associated with the user. For example, a user's credit card may provide discounts at certain stores, such as 5% cash back when shopping at a Walmart during the month of January. The account management application 327 may provide a user interface via the communication device 321 that displays information on the 5% cash back offer for the user. The platform may display only the offered benefits that are currently valid and have not expired.

Additionally, the account management application 327 may provide user with alerts via the communications application 328. In one embodiment, the account management application 327 may alert the user of benefits the user is eligible for based on the purchases the user made. In another embodiment, the account management application 327 may alert the user of benefit offers based on the location of the user. The platform 320 may monitor the location of a user based on a GPS function of the user's smart device, such as the user's smartphone, based on the where the user is currently making purchases or the like. A notification feature may be activated to inform the user of benefit offers within the geographical location. For example, if the platform 320 determines a user is within the vicinity of a Walmart based on the location of the user's smartphone or based on a recent purchase made by the user, the account management application 327 may alert the user by sending a notification to the user that the user's credit card provides 5% cash back benefit at Walmart.

Additionally, the consumer protection platform 320 may display the user's spending behavior, spending patterns and spending activity based on the monitored purchase transactions. In one embodiment, the platform 320 can also analyze purchasing activity, including spending habits, to make recommendations on new purchases, retailers to purchase from, or credit cards to use when making purchases. The recommendations may provide the user money saving offers that the user is not aware of. For example, the platform 320 may determine that a user is a frequent traveler based on their spending activities. Based on that determination, the platform 320 would recommend flight deals associated with the user's home airport and/or recommend a frequent flier credit card that would save the user money on fight purchases. In some instances, the platform 320 may allow the user to search for items or services the user would like to purchase and then display the items or services of the search results along with any benefits that correspond to the item or service in the search result. The search results may be sorted according to relevance, best bargain or the like and displayed on the user's device.

The consumer protection platform 320 also includes a product monitoring application 332 that monitors and tracks the price of items a user has recently purchased at various retailer websites. After the platform 320 receives/retrieves item level purchase data about a recently purchased item, the platform 320 may analyze the item level purchase data to see if the purchased item is eligible for a price guarantee. For example, the item level purchase data may include the recently purchased product ID and the time of purchase. The platform 320 may compare the product ID to a plurality of benefits associated with the user to determine if any of the benefits, such as a price guarantee, is applicable to the product ID. If purchased item is eligible for a price guarantee, the product monitoring application 332 may be initiated to monitor the price of the purchased item at various retailers for a period of time the price guarantee is applicable for. In an embodiment, the consumer protection platform 320 may monitor for price change for any purchase made by the user.

The product monitoring application 332 may perform price monitoring/tracking on purchased items continuously, periodically or on demand. The product monitoring application 332 may (1) request alerts from various websites that notifies the platform 320 of price changes, (2) perform a web crawl/search for current prices of the purchased using a search engine, (3) perform a search on specific websites for current prices of the purchased item, and/or (4) any other web based monitoring/tracking method to determine price changes of a purchased item at various retailers.

The electronic communications application 328 includes computer program code for receiving, storing, and transmitting electronic messages utilizing the communication device 321. For example, the electronic communications application 328 may send alerts or notifications in the form of e-mails, text messages, messages through applications, and any other form of communication. Although FIG. 3 illustrates the consumer protection platform as one system, it is important to note that there can be one or multiple systems, each with similar components that handle the various functions of the consumer protection platform 320.

The consumer protection platform also includes at least one storage 330 and an analysis module 334. The receipt management application 325, benefit policy application 326, account management applications 327 are operatively connected to the storage 330 and analysis module 334. The storage 330 may be used to store the electronic receipts, electronic copies of paper receipts, benefit policies for different financial institutions, user account information, and the like. The analysis module 334 may retrieve or receive data from the storage 330 and perform analysis on the data to determine whether the user is qualified for any benefits, consumer protections, redemptions, rewards and the like based on their purchases. In one embodiment, the analysis module 334 may perform the analysis based on a request from the account management application 327 or the communication application 328.

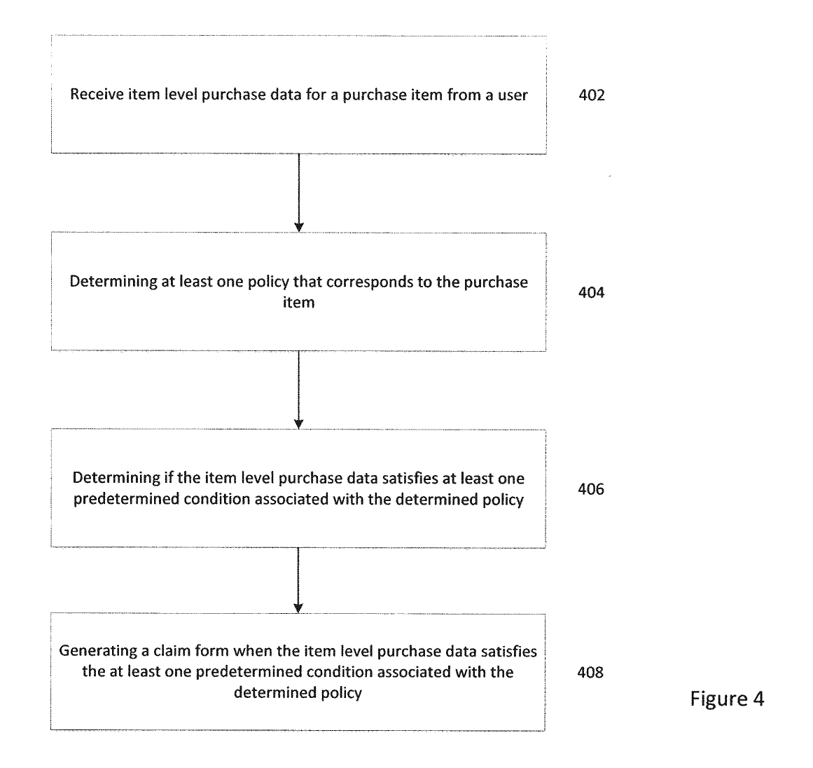

With reference now to FIG. 4, a flow chart illustrating a high-level exemplary method 400 of the electronic receipts collection and management system for redeeming consumer protections in accordance with some embodiments of the invention is provided.

In step 402, the consumer protection platform retrieves and/or receives item level purchase data for purchased item from a user. The electronic receipt collection management system may monitor a user's email for electronic receipts, also referred to as e-receipts, by connecting to a user's email account and scanning for messages for e-receipts or data associated with purchases made by the user. In one embodiment, the electronic receipt collection management may use an email parser which extracts data associated with purchases made by the user from incoming e-mails. For example, e-mail parsers can be configured to pull specific data from incoming e-mails, thereby converting unstructured e-mail data into easy-to-handle structured data. In some instances, the email parsers may parse data fields from the e-mail body and e-mail headers. The e-mail parser may be a visual parser and any other type of parser that can be used extract or retrieve data associated with purchases from a user's e-mail.

After retrieving and/or receiving the e-receipts or data associated with purchases made by the user, the collection management system may compile a list of the e-receipts or data associated with purchases made by the user. The compiled list of e-receipts and/or data may be analyzed and item level purchase data can be extracted. In one embodiment, the user device may have an application installed on it that accesses and monitors the user's email account. For example, after an application or the platform 320 connects to a user's email account, the e-mails pertaining to purchases made by the user may be parsed and item level purchase data may be extracted.

The user also may generate an electronic copy of paper receipts and transmit the electronic copy of the paper receipt to the electronic receipt collection management system. The user may transmit the electronic copy of the paper receipt via e-mail, text message, web site or via a communication application associated with the electronic receipt collection management system.

In another embodiment, the electronic receipt collection management system may monitor the user's banking accounts or other financial institution accounts for purchases. The platform retrieves or receives a user's credit card statement or the user's credit card transaction history from an online account manager to extract transactional data indicating items purchased by the user. Transaction data from the credit card statements and other bank statements may not have data regarding specific details of the purchases, such as the items purchased, the cost of each purchased item, and other critical item level data. For example, credit card statements and other bank statements do not have data regarding specific details of the purchases, such as the items purchased, the cost of each purchased item, and other critical item level data. However, the transactional data may be used to determine item level data for the purchased item. In order to determine the item level data, information may be extracted from the purchase receipts that are determined to be associated with the transaction data. The system may first determine if an electronic copy of the receipt associated with the transaction indicated on the statement has been retrieved by the consumer protection platform 320. In one embodiment, the consumer protection platform 320 matches the transaction date and/or the transaction amount with information associated with electronic copies of receipts that have been retrieved/received by the consumer protection platform and stored in storage 330. If an electronic copy of the receipt is not found by the consumer protection platform 320, the consumer protection platform sends a notification to the user requesting that the user send information related to the product or products that were purchased by either forwarding the electronic receipt to the consumer protection platform or explicitly entering the product name and uploading an electronic copy of the paper receipt. In one embodiment, the user may take a picture of the receipt and upload the picture.

At step 404, the platform determines at least one policy that corresponds to the purchase item. The platform may collect policy information from a plurality of benefit policy servers. The benefit policy servers may be any server associated with financial institution, such as a credit card company or an insurance company, or a retailer or manufacturer of goods. In another embodiment, the platform may crawl the internet or search the internet for policies and/or benefits pertaining to specific credit cards or other financial institutions. Once the policies are received they are stored in storage associated with the platform. In one embodiment, the platform monitors benefit policy servers or websites to detect changes to the policies and update the policies in the platform, in real time or periodically.

The platform may determine at least one policy that corresponds to the purchase item by matching the purchase data received from the user with a policy stored in the platform that is associated with the credit card used to purchase the item, the retailer associated with the purchased item or the manufacturer of the purchased item.

At step 406, the platform will then determine if the item level purchase data satisfies at least one predetermined condition associated with the determined policy. The policy information received by the financial institutions is stored in a structured document which can then be used for applying relevant policies for user selected cards, retailers or manufacturers. The structured document may include a set of predetermined conditions that the purchase or purchase item must satisfy in order to be eligible for the benefit, rebate, or compensation. The predetermined conditions may be extracted from the structured document and used to determine if the purchased item is compliant with the conditions. The predetermined condition may be a time from which the policy starts and ends, so a purchased item may only have that specific time frame to claim the benefit associated with the policy for the purchase of the item. For example, a policy may provide a rebate for a purchased item, if a claim is filed within 30 days of purchased. The platform will determine if the 30-day time frame has lapsed since the time of the purchased as indicated on the receipt. If the 30 days have not passed, a claim is generated for the purchased item, as described in step 408.

At step 408, the platform will generate a claim form when the item level purchase data satisfies at least one predetermined condition associated with the determined policy. In one embodiment, the platform may request a claim form from the financial institution, retailer or manufacturer. In another embodiment, the platform may access a web site or an application associated with the financial institution, retailer or manufacturer and digitally fills out information associated with purchase.

In one embodiment, the platform will provide real-time recommendations around which credit cards to use that either takes advantage of certain protections or which card optimizes points, as discussed above. For example, the platform may monitor the location of a user based on the GPS associated with the user's device, the location of recent purchases, and the like. If the user is in the vicinity of a retailer or store that is associated with a benefit offer that is applicable to the user, the consumer protection platform 320 will send a notification to the user, such as a text message, e-mail, an alert through an application on the user's device or the like.

In another example, the consumer protection platform 320 may map the location type, such as an electronic store type, to relevant benefits available on the user's credit card. For example, if a user is interested in making a purchase at an electronics store or indicates via an application on the user's device, they are about to make a purchase at the electronics store, the consumer protection platform 320 may provide details on benefits offered by different credit cards associated with the user, such as extended warranty policy.

Additionally, the consumer protection platform 320 may be provided details, either explicitly or through spending analysis of the user's spending habits, of services and types of purchases the user may be interested in. Based on these details, consumer protection platform 320 may provide a recommendation of credit cards offering benefits that would be applicable to the user.

In one embodiment, the consumer protection platform 320 categorizes the benefits and or policies from various sources applicable to the user based on the benefit type. In one instance, consumer protection platform 320 may categorize the benefits by the type of product associated with the benefit. For example, the consumer protection platform 320 may have a category of electronic product benefits, clothing store benefits, airfare benefits, and the like. When the consumer protection platform 320 determines that a user has purchased an item or has inquired about purchasing an item, the consumer protection platform 320 determines the type of item to be purchased, retrieves benefits from the category associated with the type of item, and determines if any of the benefits are applicable to the user's purchase. For example, if a user inquires about purchasing airfare tickets, the consumer protection platform 320 retrieves benefits categorized as airfare benefits, and provides the user with applicable airfare benefits.

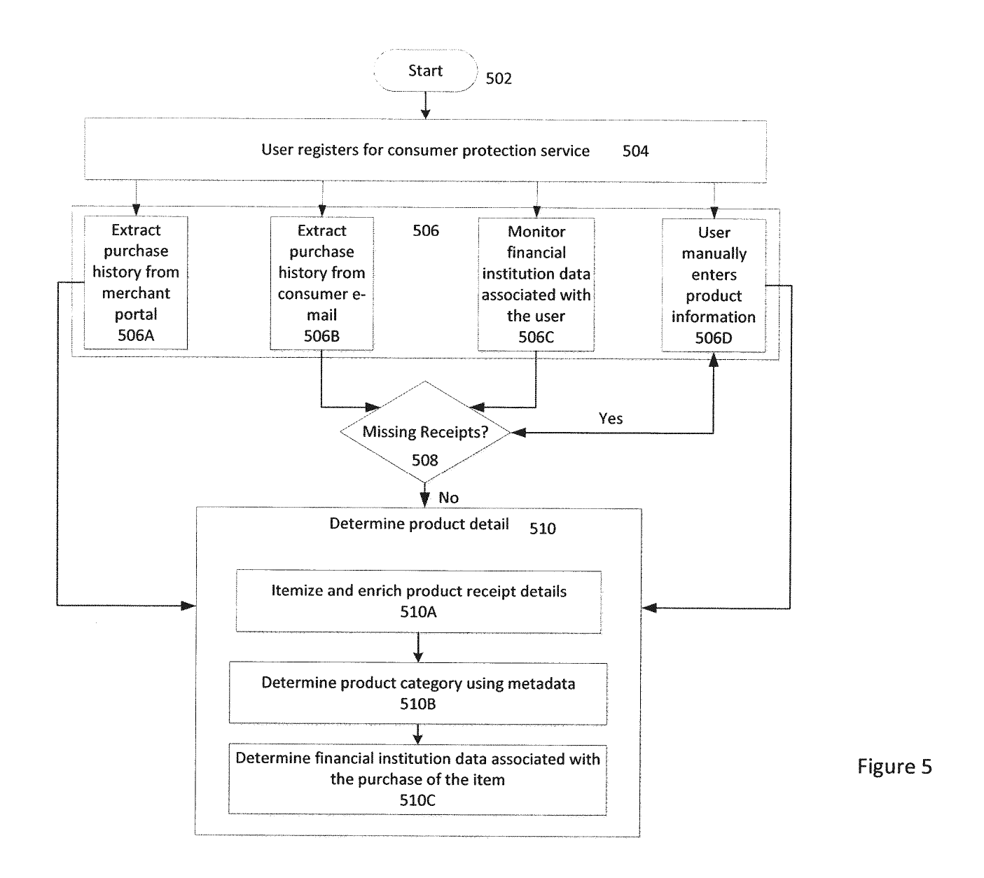

FIG. 5 illustrating a granular level exemplary method of determining item level product detail associated with the electronic receipts collection and management system for redeeming consumer protections in accordance with some embodiments of the invention.

The method begins at step 502.

At step 504, a user registers for consumer protection services. When a user registers for an account with the consumer protection platform, the consumer protection platform may create a record and store a record, often referred to as a “user profile,” in connection with the user. The user profile may include information provided by the user and information gathered by various systems, including the financial institutions, relating to activities or actions of the user. A user profile may include account and access information for various financial institutions that the user may use. For example, a user profile may include credit cards and account information associated with the credit cards that the user uses to purchase items, e-mail access information, current address, phone number and the like. The user profile is stored separately, synced with the user device, and then replicated locally on the user device. This enables quick access to the data even in offline mode and significantly reduces the load on the servers.

In one embodiment, when the user generates a consumer protection service account on the consumer protection platform, the user may subsequently access their purchase history information, link their consumer protection service account with their financial institution accounts, view benefits offered by their financial institutions, view spending patterns, and the like.

Once the user has created an account, the user can provide the consumer protection platform with a link to their e-mail, user name and password to their e-mail, and/or other permission so that the consumer protection platform can access the user's e-mail account. When the consumer protection platform links the user's account to the user's e-mail, the consumer protection platform can monitor the user's e-mail for electronic receipts. The consumer protection platform may periodically monitor, continuously monitor or retrieve the user's e-mail on demand.

To monitor the user's e-mail, the consumer protection platform uses an operation, application or the like to query the user's e-mail for indications of financial transactions or financial transactions. In one embodiment, the consumer protection platform may parse the user's e-mails to extract relevant financial transaction information or find relevant e-mails.

In addition to or alternatively, the user may scan the paper receipts and e-mail the receipts to the consumer protection platform, upload the scans of the paper receipts to the consumer protection platform, use an application associated with the consumer protection platform to take a picture and automatically upload the receipt, manually enter product information from the receipt into the consumer protection platform, or the like. In one embodiment, the consumer protection platform may have an e-mail server and a unique e-mail address. The user may be able to forward or send e-mail information associated with purchases, such as electronic receipts or copies of electronic receipts, to a unique e-mail address associated with the e-mail server of the consumer protection platform.

In another embodiment, the consumer protection platform may have a secure e-mail server associated with the consumer protection platform. The secure e-mail server will be linked to the user's consumer protection service account. The user may then have their financial institution e-mails sent to the secure e-mails server associated with the consumer protection platform.

The user can also provide the consumer protection platform with account information associated with the user's financial institutions. Similar to linking the user's consumer protection service account to the user's e-mail accounts, the user may link accounts at financial institutions to the user's consumer protection service account so that the consumer protection platform may retrieve, monitor, or track the financial transactions of the user. In doing so, the consumer protection service may access the user's account information on the financial institute's servers, such as financial transactions. The consumer protection platform may periodically monitor, continuously monitor or retrieve on demand the user's financial transactions using the user's financial transaction account.

In addition to or alternatively, the user may scan transaction statements from the financial institution to the consumer protection platform, upload the scans of transaction statements from the financial institution to the consumer protection platform, use an application associated with the consumer protection platform to take a picture and automatically upload the transaction statements from the financial institution, manually enter product information from the receipt associated with the transaction statements from the financial institution into the consumer protection platform, or the like.

In one embodiment, the user may set up forwarding or notification preferences on the user's financial institution servers to forward information associated with any financial transactions the user makes or the like. For example, a user may select preferences for their account at their credit card company's web site where the credit card company would send a message, information, notification or alert to the consumer protection platform.

In another embodiment, the consumer protection platform may have an application or operation that allows a user to scan the UPC label, product label or the like of the recently purchased item. Using this information, the consumer protection platform may prompt the user to enter a retailer. In one instance, the consumer protection platform may display for the user a set of retailers that the user has recently purchased from or predict a set of retailers that the user may have purchased the item from so that the user may select the retailer where the user purchased the product. Determining the set of retailers or predicted set of retailers may be based on the retrieved or received financial transaction information obtained from the financial institutions.

At step 506, the consumer protection platform retrieves or receives purchase history data from the user. The consumer protection platform may use the user's e-mail account, merchant portals, and/or financial institution portals to retrieve or receive the user's history data. Additionally or alternatively, the consumer protection platform may monitor the user's e-mail account, merchant portals, and/or financial institution portals continuously, periodically or on demand.

In one embodiment, the computer protection system monitors a user's e-mails by accessing the e-mail server associated with the user's e-mail account and identifies e-mails that are associated with purchased made by the user, as illustrated in step 506B. In another embodiment, the user's e-mail server would provide an API or the like that would allow the consumer protection platform access to the user's e-mail or part of the user's e-mail. Similarly, financial institutions may provide an API or the like that would allow the consumer protection platform access to the user's information associated with the user's financials. In another embodiment, the user may provide the consumer protection service/platform the username and password to the user's e-mail account or financial institution accounts.

The identified e-mails are parsed to extract purchase data from the e-mails. The purchase data may include the item purchase, UPC code, data of purchase, time of purchase, cost associated with the purchase, name and address of the retailer or merchant, and the like. The purchase data is stored in a storage associated with the consumer protection platform and associated with the user profile of the user that purchased the item associated with the purchase data. In another embodiment, the user may transmit an electronic copy of the receipt to the consumer protection platform via an API, application, web site, e-mail, text message, or any other form of transmission. Once the electronic copy of the receipt is received by the consumer protection platform, the platform may extract relevant purchase data, as illustrated in step 506D.

The consumer protection platform may also obtain a purchase history of a user from a merchant portal, as illustrated in step 506A. Similarly, the consumer protection platform may also obtain a purchase history of the user from a financial institution portal, as illustrated in step 506C. In some embodiments, the user profile includes access information for the user's account on the merchant portal and/or the financial institution portal.

If the purchase history extracted from the user's e-mail or obtained from the financial institution portal, the platform may determine if the receipt associated with the purchases data is missing in step 508. If the receipts are missing, a message, alert, notification or the like may be sent to the user to provide an electronic copy of the receipt or manually enter product information.

At step 510, product details, referred to as item level data, are determined using the retrieved/received purchase history information and/or receipts. To determine the product details, the system extracts details associated with each purchase indicated in the purchase history or receipt. For example, product detail may be parsed from the identified e-mails. Product detail may include seller retailer name, purchased item, UPC code, paid price, web address for a web site associated with the seller retailer. The product detail may also include price adjustments, such as a discount or a sale and/or return policies.

In step 510A, the purchased items, products or services may be itemized and/or categorized based on the extracted product details. Product categorization may be parsed from emails, determined from user provided or modified information, parsed from product pages on the internet, using the retailer's name, or the like. In one embodiment, the products use machine learning to categorize the products, or use metadata associated with the products to categorize the products.

In one embodiment, the purchased items, products or services are manually assigned a category by the user or by the merchant who offered the items, products or services for sale. In some instances, when a user inputs information in associated with a purchased items, products or services, the user will be prompted to select a product category or propose a product category that is associated with the purchased item, product or service.

In another embodiment, machine learning techniques may be used to define items, products or services categories (e.g. ‘Electronics’) and potential subcategories (e.g., ‘Printers’). The purchased items, products or services are automatically classified based on training data of the other items, products or services and classifications. This will also be useful when there is a new product line that has not been previously introduced in the market before, or the products are more densely populated than the training data.

Machine Learning employs program learning operations from data sets. Training data set is the data on which the machine learning programs learn to perform correlation tasks (classify, cluster, learn the attributes, et al). In one example, training data set is received from various products available at retailers or the like. The program learning operation then forms models based on the training data set. Once the models have been created and tested, they may be used to categorize and subcategorize the items, products or services.

Once the purchased items, products or services have been itemized and/or categorized, the consumer protection platform can correlate the purchased itemized or categorized item, products and services with benefits associated with the categorized or itemized item, products and services, as described below in step 510C.

At step 510C, once the purchased items are determined from the product detail and/or the purchase history information received or retrieved by the consumer protection platform, financial institution data associated with the purchase of the item is determined. For example, price protection policies, theft protection policies, rebate policies, redemption policies, extended warranties, return policies and other policies associated with the purchased item are determined.

To determine such policies, the consumer protection platform may receive or retrieve data from financial institutions. In one embodiment, the platform monitors financial institutions for policy information and/or changes to policy information, periodically or in real-time. Additionally or alternatively, the platform may crawl the web for such policy information and/or may perform a web search on policies associated with particular financial institutions.

In some instances, the platform may determine augmented insurance coverage for a user based on a user's purchase. For example, a user may purchase a rental car using a credit card. The credit card may provide a benefit offer that provides for “secondary car rental insurance” or entitles the user to upgrade to “primary rental car insurance” for only $20 for over 30 days where the policy would handle the entire claim without deferring to the user's normal car insurance policy. The consumer protection platform may provide the user information associated with both insurance coverage options.

In one embodiment, to determine policies or offered benefits that apply to the products purchased by the user, the consumer protection platform determines a benefit offer or policy that is associated with the purchased product. In one instance, the consumer protection platform may retrieve offers or benefits associated with the financial institution associated with the user, the retailer, and/or the manufacturer associated with the purchased product. The consumer protection platform then determines if any benefits offers or policies that were retrieved are applicable to the product and user.

For example, the consumer protection platform may determine that the user used a credit card to purchase a product. The consumer protection platform may retrieve benefit offers or policies associated with the credit card, the retailer where the user purchased the product and/or the product manufacturer. Then, the consumer protection platform determines if any of the benefits or offers retrieved apply to the purchased product. In one embodiment, the determination of whether any of the benefits or offers retrieved apply to the purchased product is done by matching context information associated with each benefit offer or policy and the information associated with the purchased product. For example, the consumer protection platform may search the information associated with the related benefit offer or policy with information associated with the purchased product, such as the purchased product UPC code, product name, the product category or the like.

In another embodiment, to determine policies or offered benefits that apply to the products purchased by the user, the consumer protection platform correlates the categories associated with the purchased product with correlated categories of the polices or offered benefits.

Machine learning can be utilized to categorize and subcategorize benefits offered by the financial institutions and retailers based on the products, items or services the benefit offers pertain to. For example, a set of benefits may be categorized as “extended warranty for electronics”. The “extended warranty for electronics” category may then be related to products or items that have been categorized as “consumer electronics”. By categorizing the benefits offered by benefit types, benefits pertaining to specific categories of products can easily be determined. For example, if a user purchases a computer, the purchase may be categorized as a “consumer electronics purchase”, as described in step 510B. The consumer protection platform determines the category of benefits or policies that pertains to the category of the purchased item. For example, the consumer protection platform retrieves benefits or policies categorized as “extended warranty for electronics” which relates to products categorized as “consumer electronics.” The consumer protection platform may determine which of the retrieved benefits or policies associated with the “extended warranty for electronics” category applies to the user and the purchased product.

In one embodiment, the benefit categories used to categorize the benefit offers or policies may provide conditions associated with which product categories correlate to the benefit offers or policies in the benefit categories. For example, the “price protection claims” benefit category may provide a condition that excludes consumable products that have been categorized as “food and beverage” or “health and beauty” items.

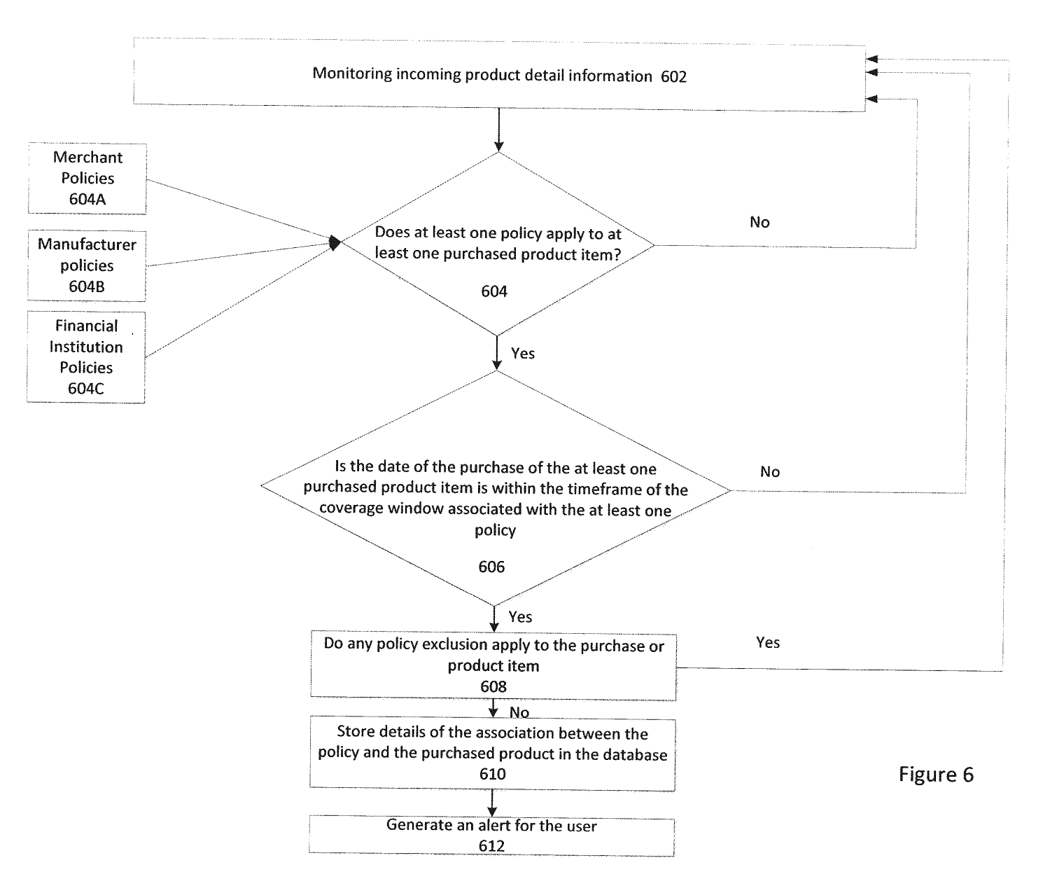

Once the consumer protection platform receives/retrieves data corresponding to at least one purchase associated with the user, the consumer protection platform can determine if the user's purchases qualify for consumer protection. FIG. 6 illustrating a granular level exemplary method of determining if the purchased items qualify for consumer protection in accordance with some embodiments of the invention.

At step 604, the consumer protection platform retrieves or receives policy information relating to products or services that have been purchased by a user. The consumer protection platform may monitor merchant portals, manufacturer portals, and financial institution portals for policies associated with the purchase of products or services. In one embodiment, the consumer protections platform may monitor for policy information continuously, periodically or on demand.

The consumer protection platform uses the retrieved/received policy information to determine if at least one policy applies to at least one purchase product item. If no policy applies to any of the purchased product items in the storage, then the platform continues to monitor incoming product detail information.

In one embodiment, each time the consumer protection platform receives or retrieves product purchase information associated with a user, a determination is made if any benefit or policy associated with the user's financial institution is applicable to the purchase of the product. Additionally, monitoring of various retailers for price information of the product in the retail market is continuous or periodic from the time the consumer protection platform receives the product purchase information until a condition is met. For example, the monitoring of retailers for the price information of the product may be continuous or periodic until a lower price product is found, until the user initiates a claim for the item, or the policy coverage expires.

At step 606, if the platform determines that at least one policy applies to at least one purchased product item, the platform determines if the date of the purchase of the at least one purchased product item is within the timeframe of the coverage window associated with the at least one policy. If the platform determines the date of the purchase of the at least one purchased product item is not within the time frame of the coverage window, then the platform continues to monitor for more incoming product detail information. However, if the date of the purchase of the at least one purchased product item is within the timeframe of the coverage window, then the platform determines if any exclusions apply to the purchase or product item.

At step 610, if no exclusion applies to the purchase or the product item, then the platform generates an alert to the user that the user is eligible to receive a consumer protection associated with a policy. In one embodiment, the notification may be an e-mail alert, a text message alert, a snail mail notification. In one embodiment, the platform may generate a claim form and submit the claim form to take advantage of the policy. Once the platform generates and submits the claim form, the platform may then generate a notification to the user that the claim has been submitted.

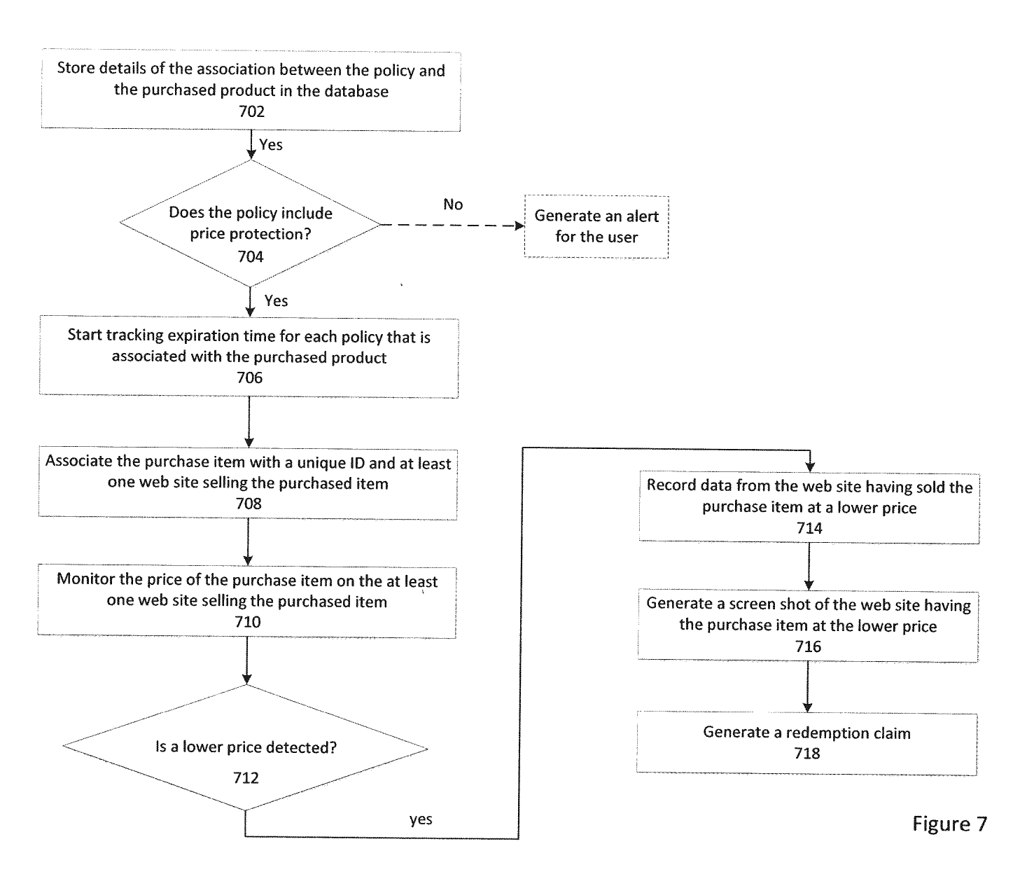

FIG. 7 illustrates a granular level exemplary method of determining if the purchased items qualify for price protection in accordance with some embodiments of the invention.

At step 702, in one embodiment, the platform stores details of the association made between the policy and the purchased product in a storage associated with the platform.

At step 704, the platform determines if the policy associated with the purchased product includes a price protection clause. In one embodiment, if the policy does not include a price protection clause, an alert is generated and transmitted to the user to notify the user that a price protection clause does not exist so that the user may reconsider their purchase. In another embodiment, if the policy does include a price protection clause, a different alert is generated and transmitted to the user to notify the user of this policy. The alert may include a text message, an e-mail, a desktop notification, a smartphone application alert and the like. In some instances, the alerts are generated and transmitted in real time as the consumer purchases the item.

At step 706, if the platform determines that the policy includes a price protection clause, then the platform starts tracking the expiration time for each policy that is associated with the purchased product.

At step 708, the purchased product is given a unique ID stored in a storage associated with the consumer protection platform. The web addresses for websites selling the purchased product are then compiled and stored in the storage associated with the purchased product.

At step 710, the consumer protection platform monitors the websites associated with the web addresses stored in the storage along with information about the purchased product. In one embodiment, the platform continuously monitors the prices of the websites continuously, periodically or on demand. In one embodiment, the websites are only monitored for the time frame of the coverage window associated with the policy, until the user initiates a claim associated with the policy or a lower price of the purchased product is found, as described in step 712.

When monitoring retailer for a lower price for the product, the consumer protection platform may generate a query of the product to generate a list of websites

At step 712, the platform determines if a lower price is detected based on the monitoring of the websites.

At step 714, if a lower price is detected, then data from the web site having sold the purchased product at a lower price is record and saved in a storage associated with the consumer protection platform. In one embodiment, the platform may take a screen snap shot of the web site selling the purchased product at a lower price, at step 716.

At step 718, the platform, using the recorded data, the screen shot, the purchase detail, and product detail to generate a redemption claim.

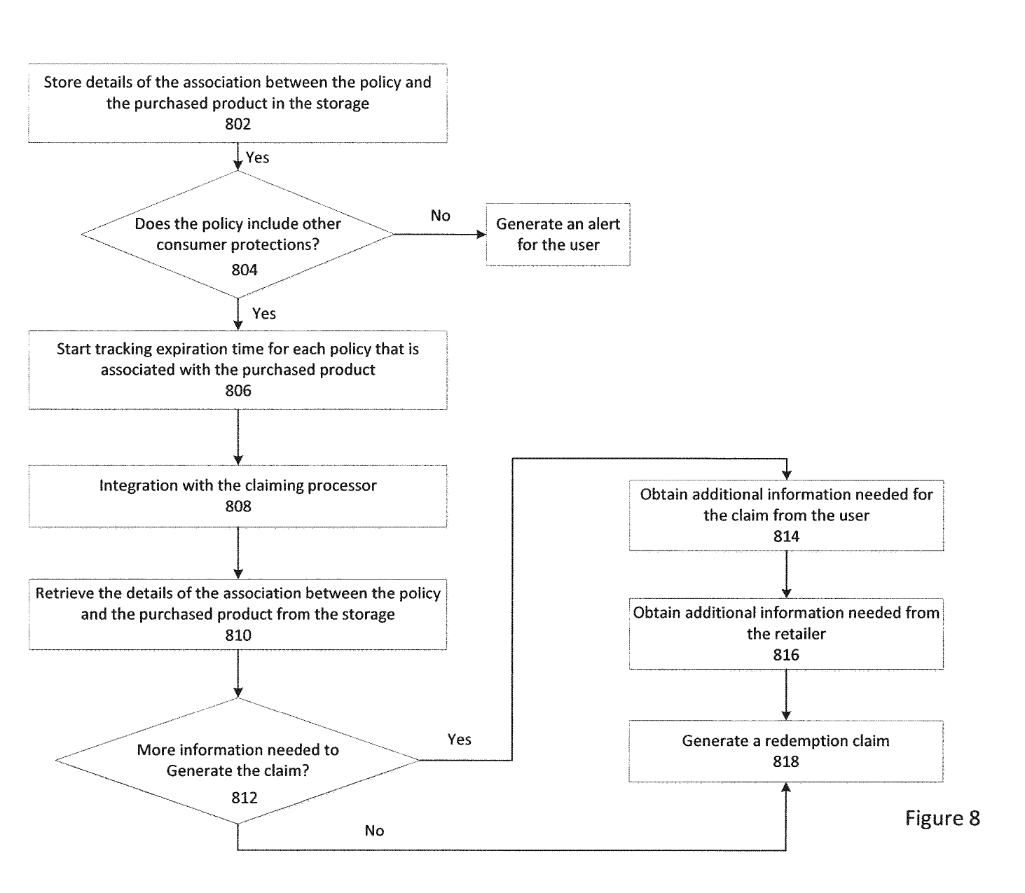

FIG. 8 illustrates a granular level exemplary method of determining if the purchased items qualify for other protections in accordance with some embodiments of the invention.

At step 802, in one embodiment, the platform stores details of the association made between the policy and the purchased product in a storage associated with the platform.

At step 804, the platform determines if the policy associated with the purchased product includes a consumer protection. In one embodiment, if the policy does not include a consumer protection clause, an alert is generated and transmitted to the user to notify the user of this policy. The alert may include a text message, an e-mail, a desktop notification, a smartphone application alert and the like. In some instances, the alerts are generated and transmitted in real time as the consumer purchases the product.

At step 806, if the platform determines that the policy includes a consumer protection clause, then the platform starts tracking the expiration time for each policy that is associated with the purchased product.

At step 808, the platform integrates the claiming processor to generate claims for purchased items based on the applicable policies. In one embodiment, the platform retrieves the claim forms from the financial institution. Generating a claim may include all or at least one of the following steps: retrieving the purchased product information, such as e-receipts, extracting information needed to make the claim, such as price paid for the purchase, generating a claim, such as filling out a claim form, and submitting the claim to the financial institution on behalf of the user.

At step 810, the platform retrieves details of the association between the policy and the purchased product.

At step 812, the platform determines if more information is needed to generate a claim. If more information is needed to generate a claim, the information is requested or obtained from the user and/or the retailer, at steps 814-816.

At step 818, the platform, using the policy information, the purchase detail, and product detail to generate a redemption claim.

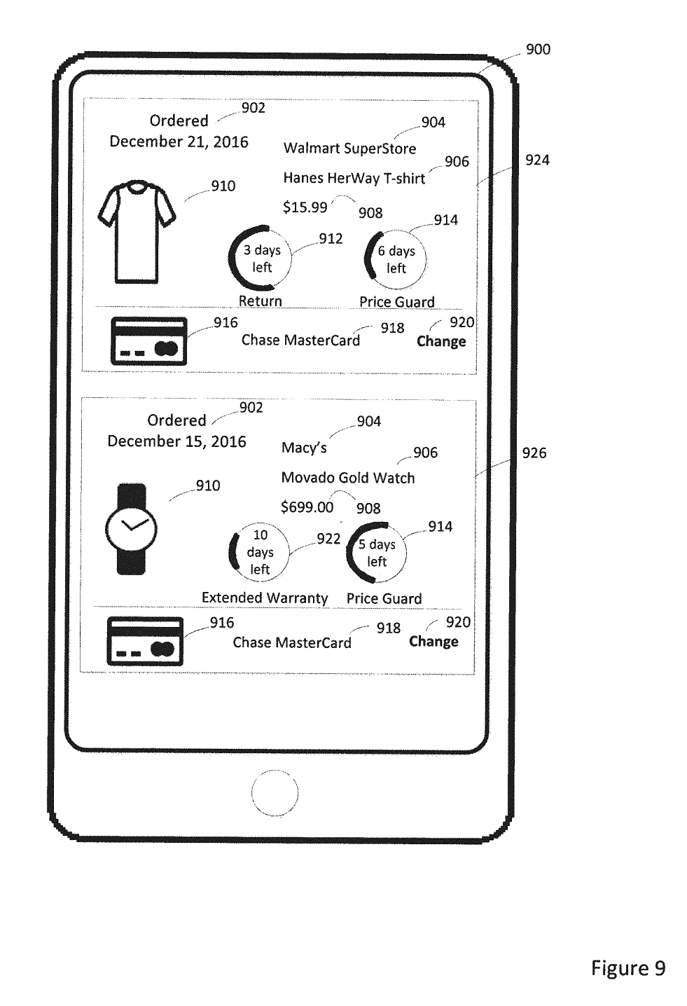

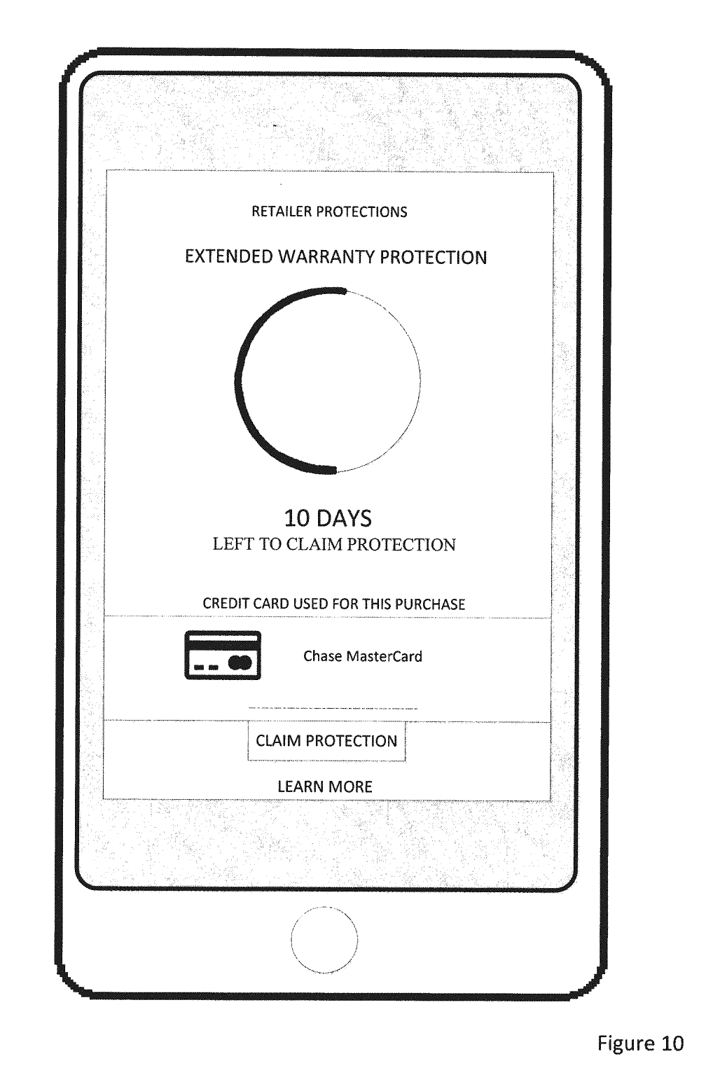

The consumer protection platform may provide the user a graphical user interface for the user to interact with, as illustrated in FIGS. 9 and 10.

Referring to FIG. 9, the consumer protection platform may provide an interface that displays products purchased by the user and associated benefits or policies that are associated with the purchased product. The user may access the graphical user interface 900 on any computing device, such as a smartphone, tablet, desktop computer, laptop or the like.

The consumer protection platform may retrieve/receive purchase information from a user and associated the purchased product with applicable policies and benefits. The graphical user interface 900 displays each of the purchases made by the user along with the applicable policies and benefits in different sections 924 and 926. In one embodiment, sections 924 and 926 may include the status of the purchase and the date that the displays product purchase information 902. The status of the purchase may include “interested in” status, “ordered” status, “cancelled” status, “return/replace” status or the like. Section 924 and 926 may also include one or more of the following: the retailer that the product was purchased from 904, the name of the purchased product 906, the price paid for the product 908, and an image of the purchased product 910. Additionally, each section includes the financial institute used to pay for the item 916 and 918. In one embodiment, the user may change any incorrect information by choosing the link to change information 920.

Each section 924 and 926 pertaining to a particular purchase may include benefits or policies associated with the purchase 912 and 914. For example, section 924 displays information associated with the purchase of a “Hanes HerWay T-Shirt”. The retailer that the T-Shirt was purchased from 904 or the credit card used to make the purchase 918 may provide a return policy and a price protection guarantee for the purchased product, the T-Shirt. The benefits associated with the purchase may be indicated on the graphical user interface. For example, the return policy and the price guard policy are represented in the GUI as 912 and 914. Additionally, the benefits or policy displayed in the GUI may include a countdown element that will indicate to the user the amount of time left to claim the benefit or policy, or the amount of time left before the benefit or policy expires. For example, in reference to the T-Shirt purchased by the user, the return 912 element indicates that the user has 3 days left to take advantage of return policy and the price guard 914 element indicates that the user has 6 days left to take advantage of the price guard benefit.

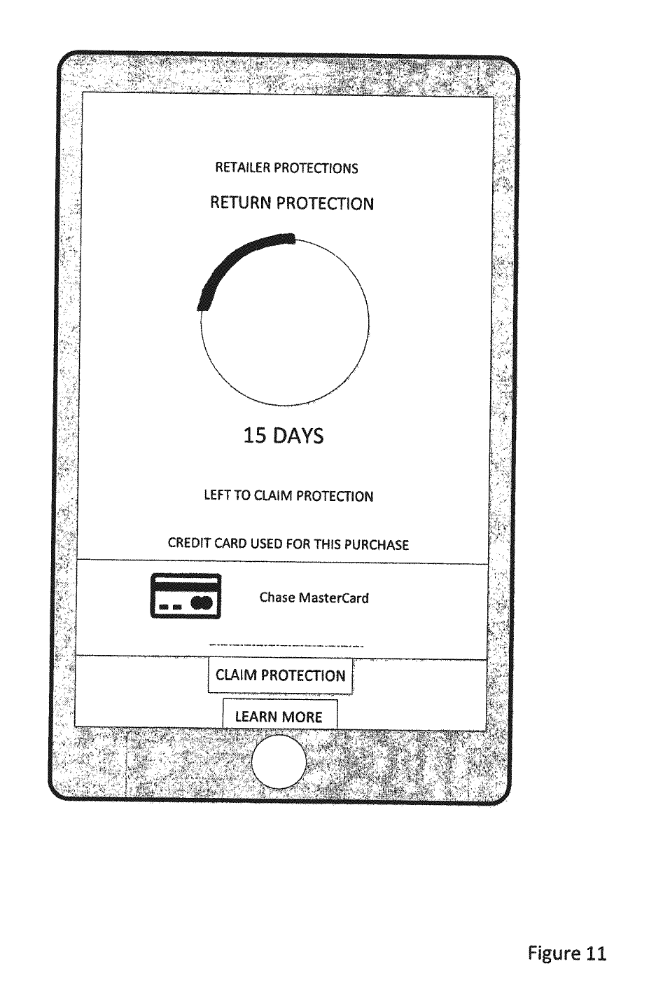

If the user wishes to take advantage of the benefit or policy illustrated in one of the sections 924 or 926 displayed in the GUI, the user may select section of interest. For example, the user may choose to take advantage of the extended warranty associated with the watch purchased by the user 926. In another embodiment, the user may select the benefit or policy associated with each section. For example, a user may be interested in taking advantage of the extended warranty benefit 922 associated with the purchase of a watch 926. After selecting the extended warranty benefit 922 element, the user may be presented a user interface that provides specific information associated with the benefit or policy and/or elements that would allow the user to claim the benefit, as illustrated in FIG. 10 and FIG. 11.

In reference to FIG. 10, when a user clicks on a button element associated with the benefit or policy 912, 914, 922 as displayed in FIG. 9, specific information relating to the benefit or policy is displayed. FIG. 10 illustrates an example of when a user selects the extended warranty benefit element 922.

In one embodiment, a financial institution, such as a credit card, may provide automatic benefits or policies based on the purchase of a product. For example, as illustrated in FIG. 10, the user's credit card may provide the user automatic extended warranties on specific items purchased by the user.

After the consumer protection platform, as described above, determines that a user has purchased a product that is covered by a credit card's policy such as an automatic extended warranty, information associated with the policy is displayed to the user. The information may include, but is not limited to, the type of benefit or policy awarded to the user, which financial institution is offering the benefit or policy, any time constraints associated with the benefit or policy, and an option to learn more about the benefit or policy. For example, in FIG. 10, the user interface displays that the benefit or policy is a credit card protection that provides the user extended warranty protection and that the extended warranty provided by the user's Chase MasterCard. The user interface also displays the expiration date of the extended warranty and a graphical representation of the time left until the expiration date. Additionally, the user interface provides the user with a “learn more” element. If the user selects the “learn more” element, the user may be directed automatically to a website, provided a link to a website, another user interface, or the like that provides the fine print associated with the extended warranty protection provided by the Chase MasterCard.

FIG. 11 illustrates an example of a user interface that allows a user to submit a claim to take advantage of a benefit or policy.

A financial institution or retailer may provide benefits or policies based on the purchase of a product, but the user must take active steps to redeem the benefits or take advantage of the policies. The consumer protection platform 320 allows a user to view benefits or policies associated with the purchased product and provide a mean for redeeming the benefit or claiming a right to enforce the policy. In some embodiments, the consumer protection platform automatically claims the benefits or policies on behalf of the user. In other embodiments, the consumer protection platform allows a user to select benefits or policies the user would like generate claims to. For example, as illustrated in FIG. 11, a retailer, such as Amazon.com, may provide a user return protection on specific items purchased. However, the retailer may only provide a certain number of days in which the purchased item can be returned. Furthermore, the user may be required to fill out a return forms, answer a set of questions, provide other information and/or the like prior to returning a purchased item. The consumer protection platform provides a user interface that displays the time limits on the policy, such as the number of days left to return an item, and a button that allows the consumer protection platform to process the return protection claim. If the user selects the “claim protection” button as displayed in FIG. 11, the consumer protection platform may fill out any required forms, answer questions related to the return, provide other information like receipts, and/or the like in order to process the return protection claim. In an embodiment, the consumer protection platform may generate a claim form, a package of documents that need to be completed by the user, and/or instructions on how to file the claim and provide it to the user. The user can then file the claim. In another embodiment, the consumer protection platform may file the claim on behalf of the user.

The user may also learn more about the extended warranty protection by selection the “learn more” button. The user will be provided the agreement associated with the extended warranty protection selection.

Although the consumer protection platform as described above relates to benefits and policy of purchased products, the consumer protection platform may be utilized to provide the user benefits or policies associated with products the user may be interested in purchasing. The platform may provide the user a search feature. The user may be able to search for products or services that the user is interested in purchasing. The platform may provide deals or benefits associated with the product or service the user is interested in purchasing. In another embodiment, the platform may provide benefits or policies that the user may also purchase that are associated with recently purchased products.

In one example, the platform may receive indication of a user's interest in tickets to a concert or sporting event or may receive information on recently purchased tickets. Some card issuers associated with the user may offer presale/preferred seating tickets to hard-to-get-into concerts and sporting events or others offer cheap seats. The platform may provide such deals associated with tickets the user is interested in purchasing.

In another embodiment, the platform may provide the user with credit cards not associated with the user's account that would provide benefits on the user's potential purchases. For example, the platform may provide the user a list of credit cards that provide presale/preferred seating ticket benefits. The user may then choose to apply for the credit card.

In another example, credit card companies sometimes offer deals on rental car insurance coverage. According to a 2007 survey, one-third of drivers spring for extra collision insurance when they rent a car, and 56 percent either don't think their credit card would cover it or don't know for sure. But most credit cards offer collision insurance for rentals, covering whatever your primary auto insurance won't.

When the platform receives information associated with a user's interest in purchasing a rental car, the platform may provide the user with policies associated with at least one credit card that provides benefits when purchasing the rental car.

For example, prices may vary for the purchase of rental car insurance associated with the purchase of the rental car. A loss-damage waiver when renting a car could costs around $10 to $20 a day. If the user uses a credit card to purchase the car rental that includes rental car insurance that covers loss-damage, the user may not have to separately purchase the loss-damage waiver from the rental car company. In one embodiment, the platform may display, to the user, the amount of savings on the purchase.

In another example, a user may indicate interest in buying a product or the platform may receive information on a product purchased by the user. The platform may indicate to the user guaranteed return benefits associated with the user's credit cards. For example, a user may have buyer's remorse but it may be too late to return an item to the retailer from which the user purchased the item. Some credit cards will refund your purchase. The platform may provide information on the credit cards associated with the user that offer refund guarantees. The platform may also provide additional information on limitations to the refund guarantee. For example, card issuers may put their own dollar cap on the perk. The platform will display these caps to the user.

In another example, in response to a user's indication of interest in buying a product or of purchase of a product, the platform may provide the user with credit cards that provide an extended warranty. For instance, a user may drop their new gadget three days after the manufacturer's warranty expired, the credit card they used may provide the cost of replacing or repairing the new gadget. The platform may provide the user benefit information associated with their purchase or potential purchase along with any fine print restrictions on the benefits.

In another example, in response to a user's indication of interest in buying a product or of purchase of a cell phone, the platform may provide the user a repair/replacement protection plan for the cell phones provided by the user's credit card. In one embodiment, the platform may also provide the user any specific costs that may be associated with the repair/replacement cell phone. For example, the platform may provide the user with credit card information associated with the replacement/repair benefit. The platform may also indicate any additional co-pay the user may have to provide in order to gain benefit of the replacement/repair benefit.

Additionally, if the user claims the benefit of the repair/replacement benefit for the cell phone associated with the user's credit card and the cell phone is damaged or stolen, the user may instruct the platform claim protection. In such an instance, the platform may generate and provide a message to the user requesting information needed to file the claim. For example, the platform may determine that a police report or other paper work is needed to file the claim. The platform will then message the user via e-mail, text message or the like to provide the police report or other paper work.

In another example, if the platform receives or retrieves information associated with purchases or potential purchases associated with travel plans, such as flight tickets or hotel reservations, the platform may provide the user credit cards that provide travel cancellation insurance or other travel insurances, such as emergency travel assistance. Travel cancellation insurance reimburses you the cost of nonrefundable flights if an emergency or illness derails your travel plans. A handful of cards offer protection against travel delays also. The emergency travel assistance may help a user find an American doctor, replace a stolen passport or translation services over the phone.

In another example, if the platform receives or retrieves information about a user's interest in credit cards that provide cash, the platform may provide the user with at least one credit card that would offer ATM functionality without using the ATM.

In another example, if the platform receives or retrieves information about a user's interest in credit cards that provide cash, the platform may provide the user with at least one credit card that would offer ATM functionality without using the ATM.

In another example, a user may use a query function in an application associated with the consumer protection platform to determine if any credit card associated with the user has roadside assistance benefits. For instance, if a user's car breaks down on a local road unfamiliar to the user, the user may perform search for credit card benefits associated with the user offering roadside assistance benefits. The platform may display, in response to the user's search, the roadside assistance benefits of at least one credit card associated with the user. In one embodiment, the user may be provided other offers for roadside assistance benefits from other sources, such as AAA or a local towing company.

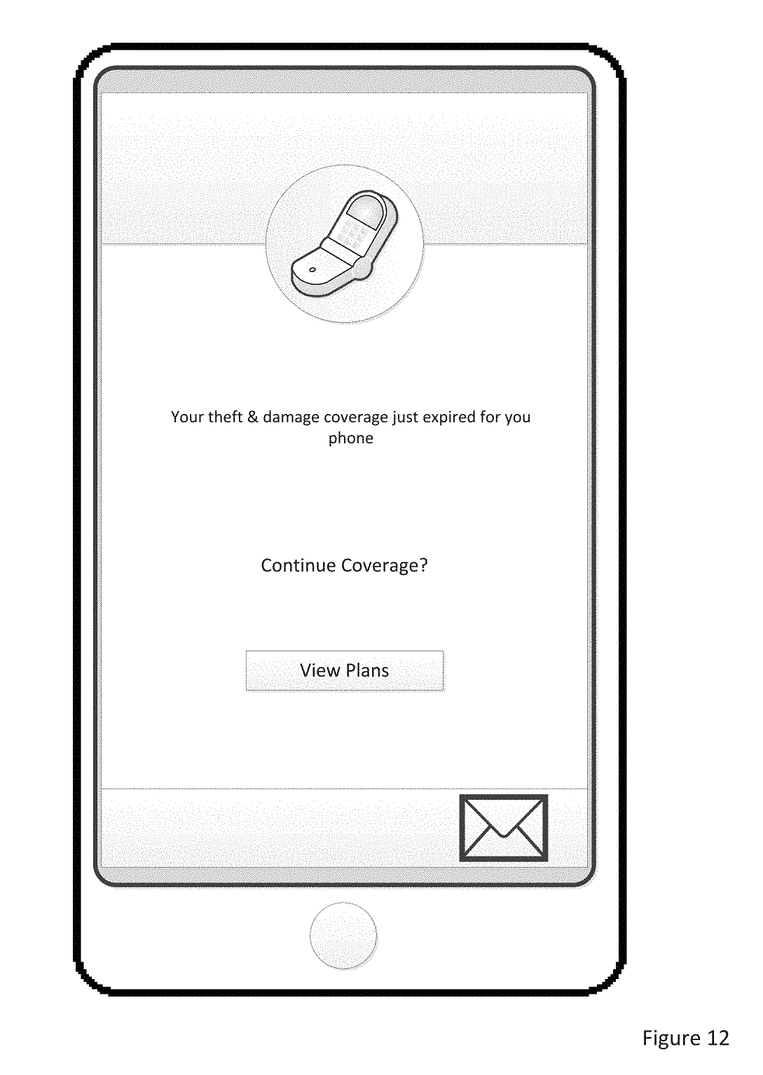

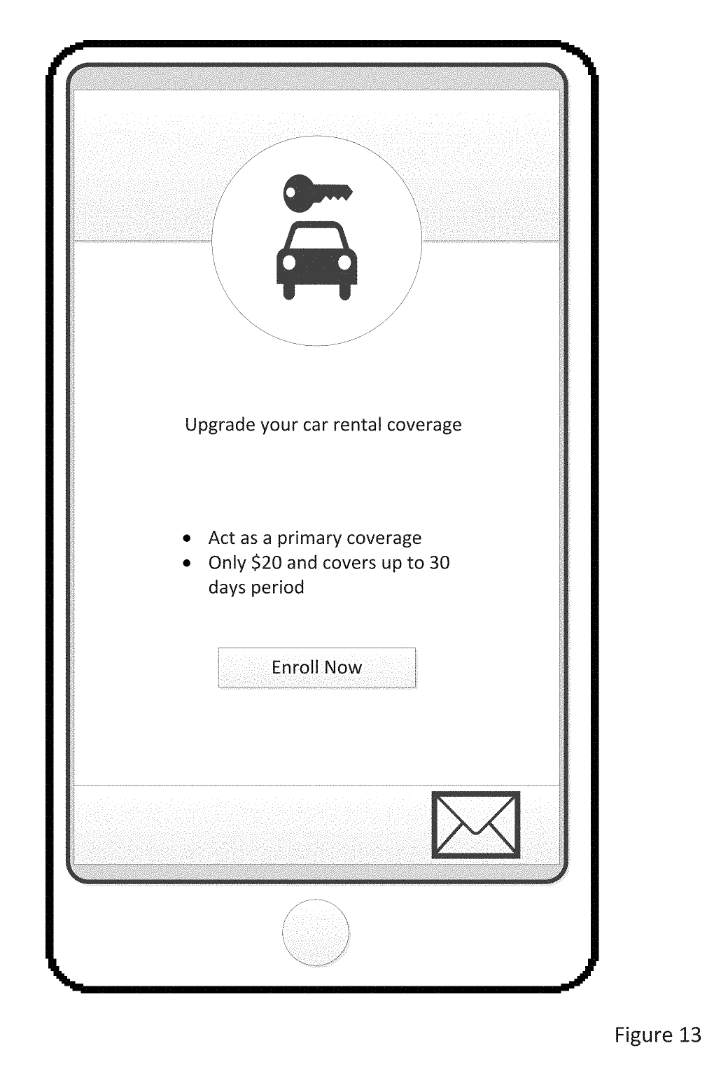

FIGS. 12-13 illustrates an example of notification sent to a user informing them of related or new benefits or policies they may be interested in.

In one embodiment, the consumer protection platform 320 provides a notification to a user regarding benefits or policies that are soon to expire or upgrades of benefits or policies based on purchases. Providing such notification messages allows companies, such as retailers, banks, or insurance companies, and other companies that present users with offers, to get new offers in front of users that are likely to purchase the new offers or upgrade their existing benefits or policies. In other words, the notification messages allow retailers to upsell benefits or policies associated with the purchases made by a user.

To generate the notifications, the consumer protection platform 320 retrieves information associated with benefits or policies and monitors the expiration of the benefits or policies. The consumer protection platform 320 may employ a notification distribution module that generates notification messages pertaining to the expiration of benefits or policies near or around the time the benefits or policies are set to expire. The notification distribution module also generates notification messages for upgrades to existing benefits or policies. To generate the notification messages, the consumer protection platform 320 may retrieve additional information associated with a benefit or policy that is about to expire or a newly purchased benefit or policy. Then, the consumer protection platform 320 transmits the additional information to the user device within the notification message; thereby, allowing the user to purchase or upgrade the benefit or policy via the notification message.

For example, as illustrated in FIGS. 12-13, the consumer protection platform generates a notification message to be transmitted to a user's smartphone. The user, via an application on the user's smartphone associated with the consumer protection platform, may view the notification. The notification message may also include a selectable object allowing the user to view benefit or policy options and/or enroll in a benefits or policy. In one embodiment, once a user selects the selectable object, they may be automatically enrolled in the benefit or policy. Information used to enroll the user in the benefits or policy is stored as part of a user's profile in the consumer protection platform 320. If information is incomplete or if more information is needed to complete the enrollment, the user may be prompted to enter in the additional information.

Specifically, FIG. 12 illustrates a user interface displaying a notification message. The notification message alerts the user that their coverage of an existing benefit or policy is about to expire. Additionally, the notification message allows a user to view new plans or extend the benefit or policy that is about to expire. Once the user selects the “view plans” selectable object within the user interface, the user will be redirected to a new user interface or a pop-up box will be displayed. The new user interface or the pop-up box will include the plans that the user can purchase or allow the user to extend their existing coverage that is about to expire.

FIG. 13 illustrates user interface displaying another notification message. The notification message alerts the user of any upgrades to the benefits or policies associated with purchases made by a user. The user, in this example, purchased a rental car. Based on the purchase of the rental car, a notification message is displayed on the user's device. The notification message includes an option to upgrade insurance coverage for the car rental. In one embodiment, the notification message includes information about the upgrade, such as the cost and time period associated with the upgraded benefit or policy.

Additionally, the consumer protection platform may provide notification messages associated with changes to travel related purchases made by the user. As discussed above, the consumer protection platform 320 may provide notifications of travel benefits to a user at the time the user makes travel related purchases. The consumer protection platform 320 may also provide notifications related to changes to the user's travel plans, such as flight delays and/or benefits or policies covering flight delays. For example, the platform may receive or retrieve information associated with purchases associated with travel plans, such as a flight ticket. Based on the received/retrieved information, the platform may notify the user of updated travel information and benefits or policies that apply to the updated travel information, such as reimbursements for flight delays from credit card protection benefits.

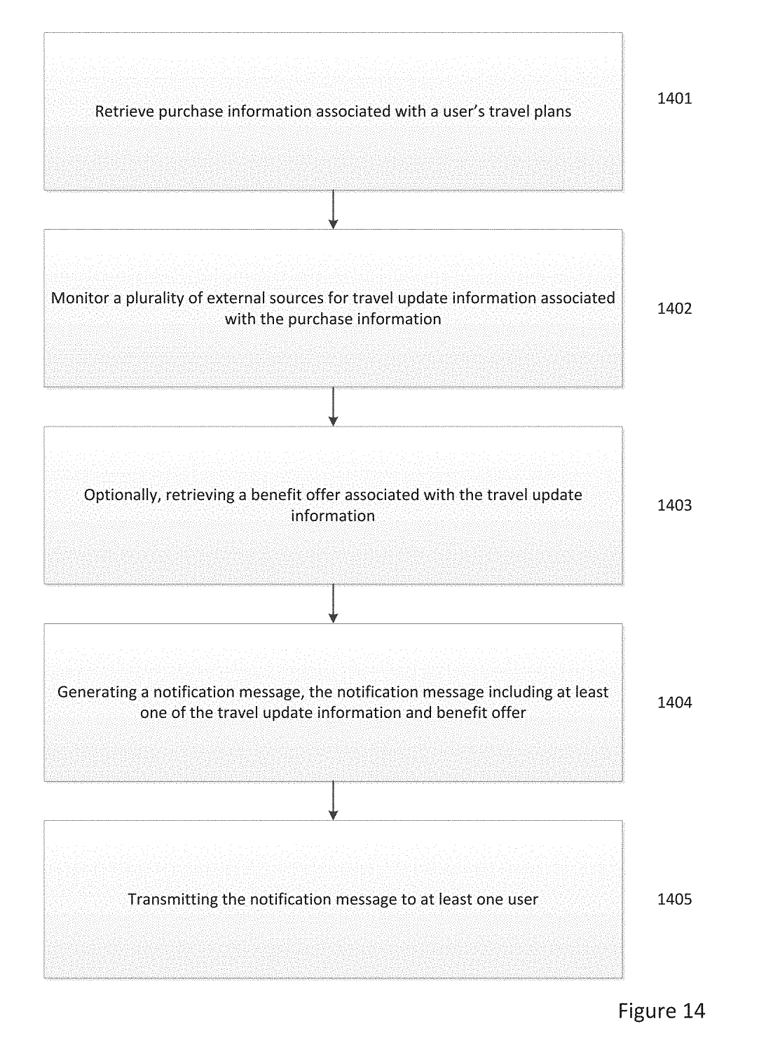

FIG. 14 provides a flow chart of the illustrating the method used to notify a user of updated travel information and travel benefits.

In step 1401, the consumer protection platform retrieves or receives information associated with a user's travel plans. The consumer protection platform may retrieve travel purchase information from a user's e-mail or may receive travel purchase information from the user. The consumer protection platform will extract additional information associated with the user's travel plans, such as the date/time of the flight, the airline, and/or the flight number.

In step 1402, the consumer protection platform may retrieve travel update information associated with the extracted additional information from various external sources. For example, the consumer protection platform may query an external source to determine if a flight purchase by the user has been delayed.

In step 1403, the consumer protection platform may, optionally, determine whether any benefits associated with the travel update information are being offered. For example, the consumer protection platform may query additional external and internal sources to determine if the airline associated with the flight purchased by the user is providing reimbursements for the flight delay or if the credit card used to purchase the flight ticket includes flight delay reimbursements.

In step 1404, the consumer protection platform may generate a notification message. the notification message may include at least one of the travel update information and the benefit offer.

In step 1405, the consumer protection platform transmits the notification message to the user. The notification message may be transmitted via a telephone call, a text message, an alert on the user's device, an e-mail message, and the like.

In one embodiment, after the consumer protection platform may transmit a first notification message informing the user of the updated travel information in real-time, such as a flight delay. The consumer protection platform will then monitor the external and internal sources for any benefits that are offered related to the flight delay, such as reimbursement due to the flight delay by the airline or credit card company. If a consumer protection platform detects benefits that are offered related to the flight delay, a second notification message will be transmitted to the user regarding the offered benefit. The notification message, in one embodiment, may include a selectable object allowing the user to claim the benefit.

In another embodiment, if the user selects to claim the travel benefit, the application on the user's device associated with the consumer protection platform may initiate a chat session, wherein the user can claim the travel benefit via the chat session. For example, when the chat session opens, an agent may initiate a conversation with the user and request information associated with the offered benefit, such as a reimbursement during a flight delay. In one embodiment, the agent will send selectable objects that the user can select, wherein the selectable objects are topics for which the chat session was initiated. Once the agent receives the requested information, the agent may request the user submit an image of documents associated with the offered benefit that would be needed to process a claim for the benefits. For example, the user may be requested to submit a picture of a receipt for food that was purchased during a flight delay because food reimbursement is part of the offered benefit. Based on the information received through the chat session, the customer protection platform will file the claim with the company offering the benefit. The chat session is described in greater detail below.

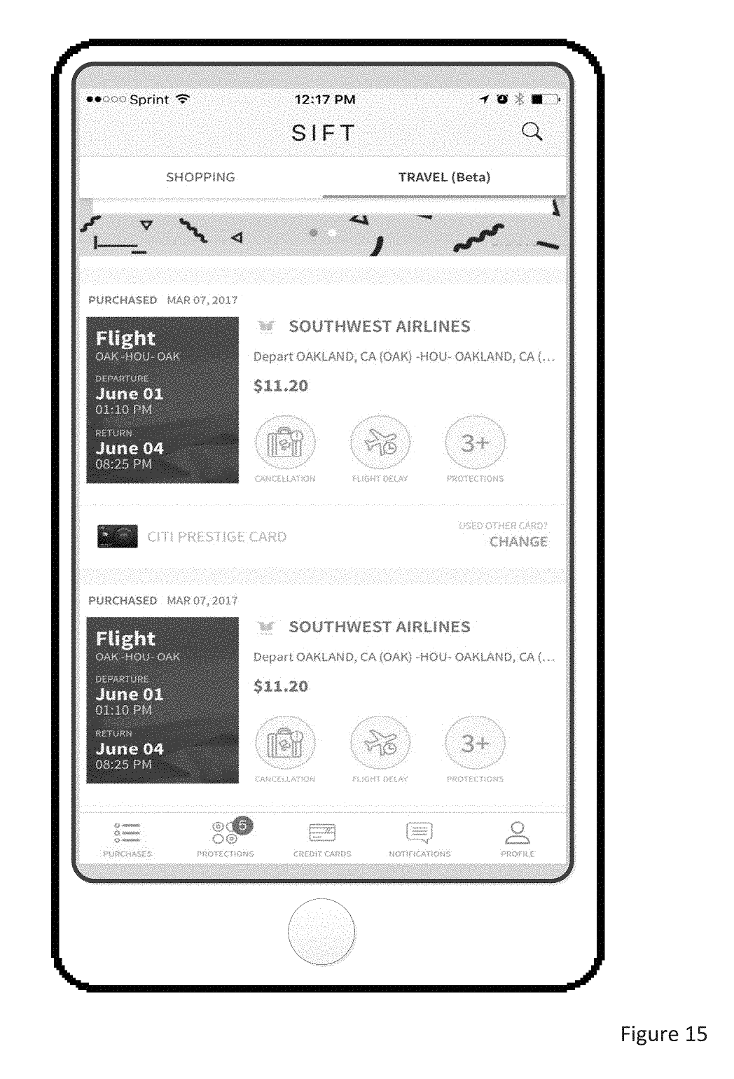

FIGS. 15-17 illustrate user interfaces that provide the user travel information and benefits offered with travel information.

Specifically, FIG. 15 illustrates a user interface that displays flight information of a flight purchased by a user. The user interface may include flight details, purchase information associated with the purchase of the flight, and a set of selectable objects allowing the user to modify the purchase of the flight. For example, the set of selectable objects may include: a cancellation object, a flight delay object, and a protections object. By selecting the cancellation object, the user may be able to modify or cancel the user's flight. By selecting the flight delay object, the user is able to see the flight status and other flight related information. By selecting the protections object, the user is able to see different protections offered by either the credit card used to pay for the flight or protections offered by other companies related to the flight. For example, the protections object may include protections that the user can purchase such as travel insurance.

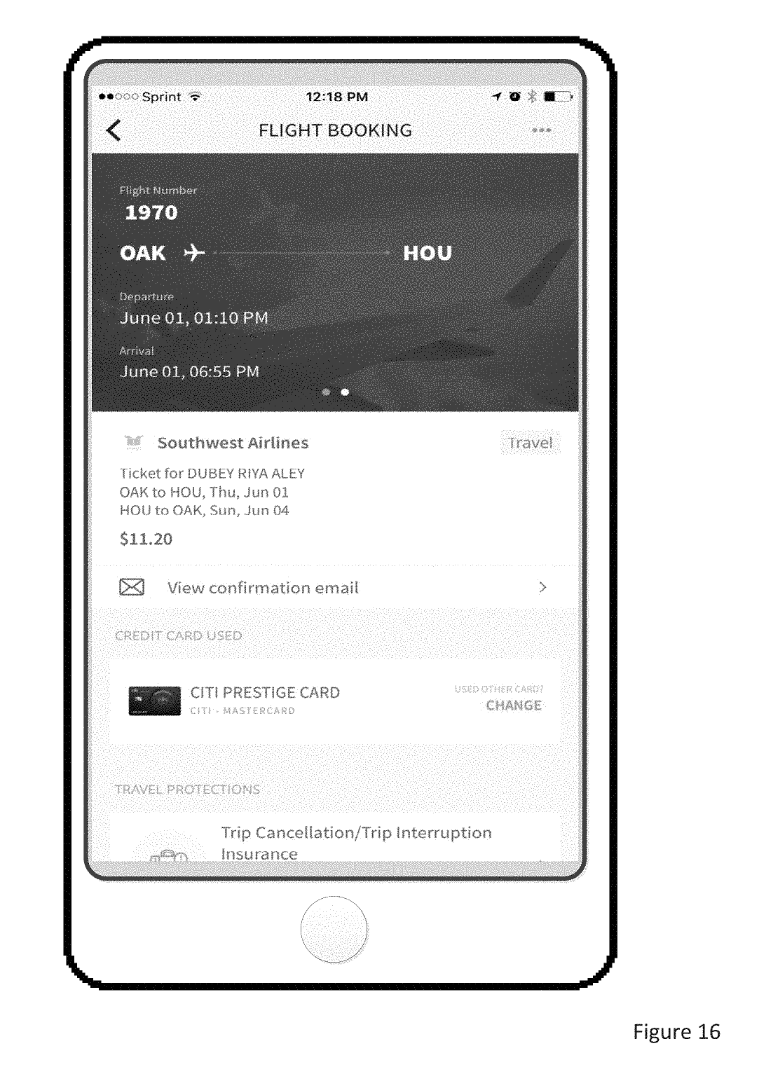

FIG. 16 illustrates a user interface that provides the user travel information associated with a purchased travel plan. For example, the user interface displays flight booking information.

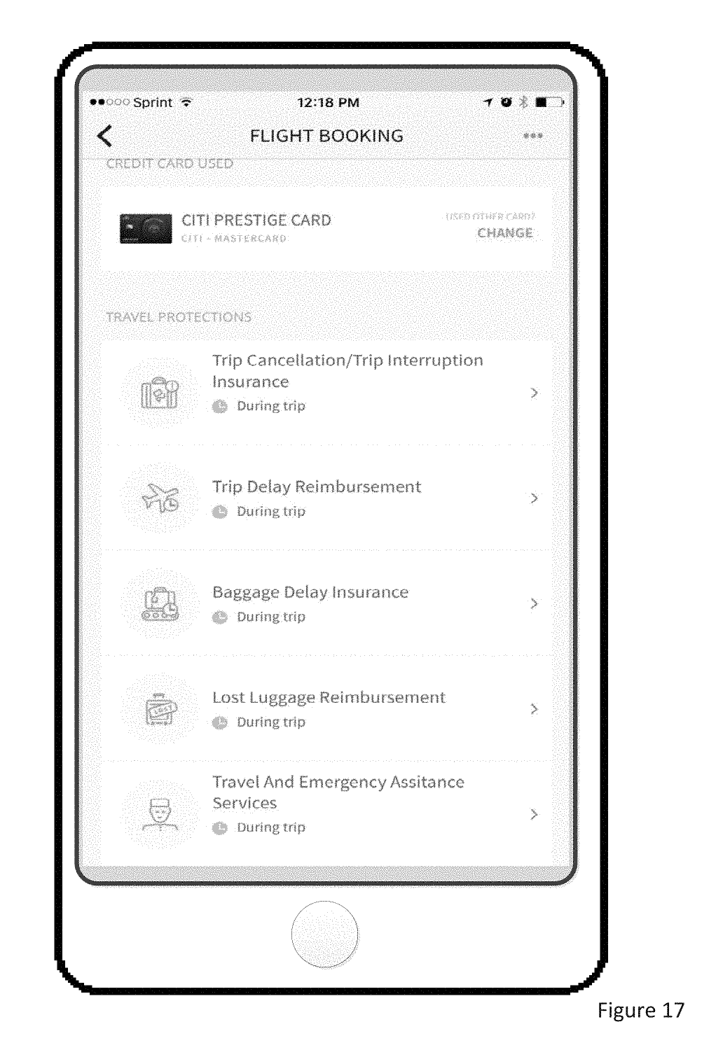

FIG. 17 illustrates a user interface that provides travel protection selectable objects allowing the user to select and purchase or claim the travel protections.

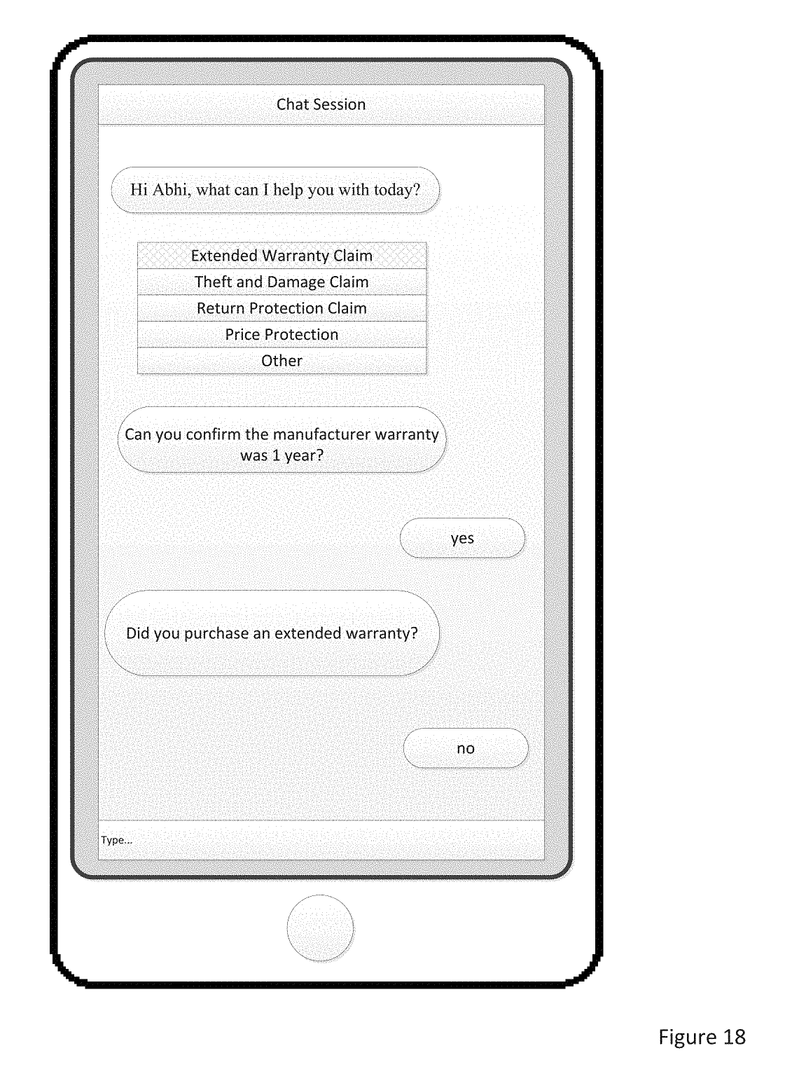

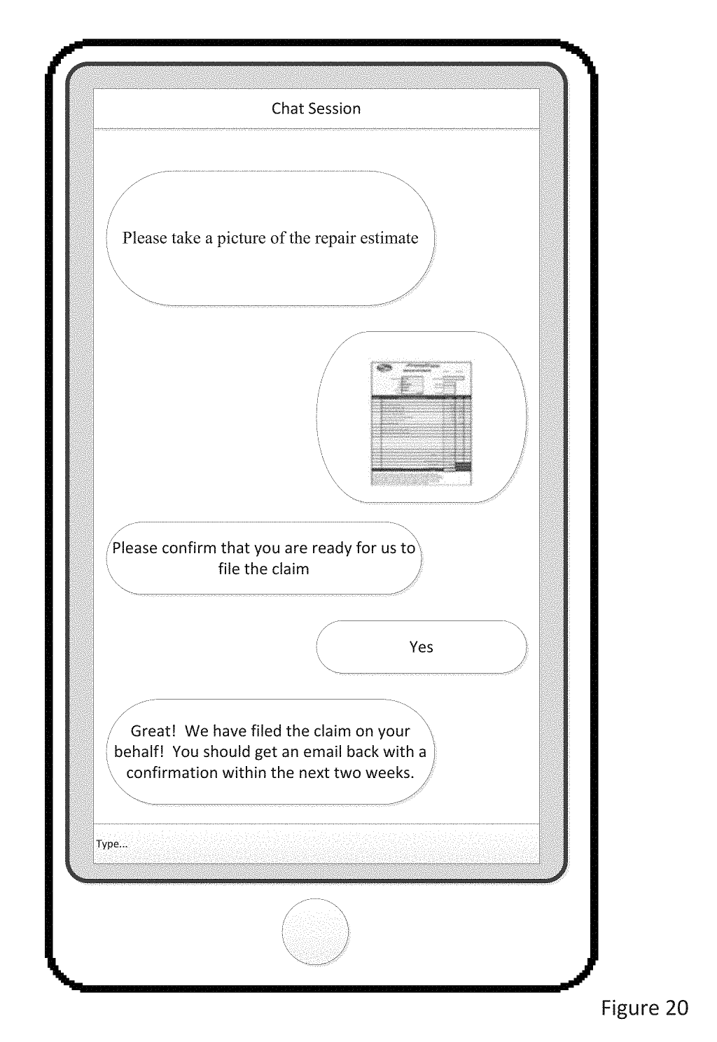

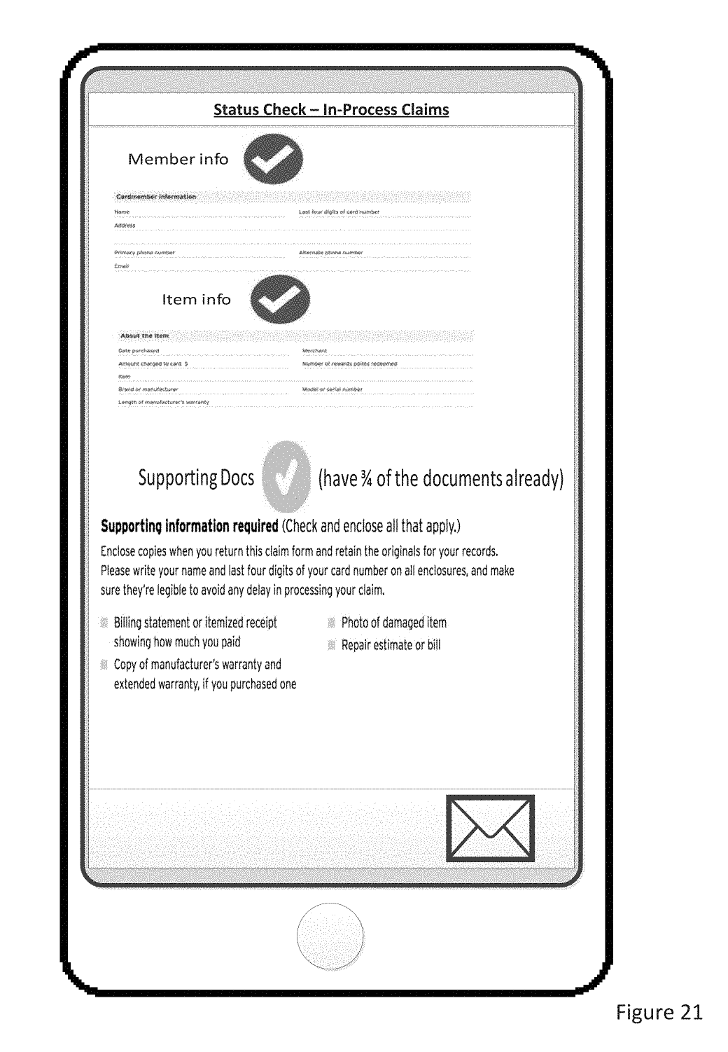

FIGS. 18-21 illustrates an interactive chat session for customer service.

In some embodiments, the consumer protection platform 320 provides customer service in the form of interactive chat sessions. For example, if a user has a question about benefits or policies or has a question related to a purchase of a product, the consumer protection platform provides chat, SMS or text messaging capabilities. The user would be able to ask questions and/or relay concerns via an interactive user interface in real-time and receive real-time answers and solutions.

In one embodiment, an automated agent may be use facilitate communication between the customer protection platform and a user. The consumer protection platform employs artificial intelligence techniques to handle communication with users.

A user initiates a chat, SMS or text messaging session by entering text into a text box on an interactive user interface or by selecting a chat, SMS or text messaging option on the user's device or within an active web page/application. The user may also initiate the chat by using a voice assistant associated with computing devices, such as Siri®, Alexa®, and the like. In one embodiment, the user initiated chat, SMS or text message session is tied to a purchase of a product. For example, via an application associated with the customer protection platform, a user may select a help or customer service button when viewing a purchased product. The selection of the help or customer service button initiates a chat, SMS, or text messaging session. The initiated chat, SMS, or text messaging session may employ an automated agent and or a combination of an automated agent and live agent to assist the user.

For example, once the user initiates a session, the automated agent may transmit an opening message to the user requesting information on how the automated agent may help the user. In one embodiment, the automated agent may provide selectable objects within the interactive user interface. Each of the selectable objects may be associated with a service provided by the customer protection platform 320. For example, in FIG. 18, the automated agent provides a set of objects the user may select from, which include “Extended Warranty Claim”, “Theft and Damage Claim,” “Return Protection Claim,” “Price Protection,” and “Other.” Based on the user's selection of the selectable object or based on the text input by the user, the automated agent will prepare a response associated with the topic, as illustrated in FIG. 18. In FIG. 18, based on the user's selection of “Extended Warranty Claim,” the automated agent derived an initial information gathering question related to the topic of an Extended Warranty Claim, “Did you purchase an extended warranty?” In order to derive this initial information gathering question, the customer protection platform stores the set of objects that a user can select from, such as the “Extended Warranty Claim” object. Each object in the set of objects is mapped to a set of initial information gathering questions also stored on the customer protection platform. Once a user selects an object, the customer protection platform determines which initial information gathering question the object is mapped to, and provides that initial information gathering question to the user via the automated agent. Similarly, each set of initial information gathering questions is mapped to a set of possible answers that a user may input and each possible answer from the set of possible answers is mapped to a response that the automated agent may provide. This mapping of information sets of questions and answers provides for a user and automated agent to converse in an informative manner. In another embodiment, through the automated agent, a user may ask questions related to understanding different policies related to credit cards, retailers, insurance and the like, and the automated agent may answer the questions and/or recommend the user take advantage of the policies, which may include filing claims on behalf the user. For example, a user may ask “what is the return policy on a watch.” Based on the sentence, the automated agent may return a return policy associated with the watch and/or may provide the user a blank or filled out return form associated with the purchase of the watch.

To that end, the customer protection platform comprises a set of trained models that are able to provide answer to questions a user may ask. To generate and train the models, initially, logs comprising user questions and answers to the questions are analyzed. The analysis of the logs helps determine what the users are trying to ask and what type of answers the users are expecting, and helps generate and train machine learning models. The trained machine learning models are able to extract the intent of the questions posed by the user. For example, a trained model can determine that a user question “what is the return policy on a purchase of a watch?” and another user question “I want to return this watch”, mean the same thing. The trained models allow the customer protection platform to match both of those questions to correct intent and produce the correct answer. For example, for both the questions “what is the return policy on a purchase of a watch?” and “I want to return this watch”, the customer protection platform can provide information associated with the return policy associated with the purchase of the watch.

In order to extract the intent of the question posed by the user, the questions are analyzed using classification methods. In one embodiment, a pattern matching model may be used to classify the text and produce a suitable response for the user. When a question is received from a user, the pattern matching model goes through all the patterns that were manually entered and stored until it finds a pattern which matches user's question. If a match is found, the customer protection platform uses the template that corresponds to the matched pattern to generate a response. For example, for the question “what is the return policy on a purchase of a watch,” the pattern matching model goes through all its question patterns until it finds a question pattern that matches “what is the return policy on a purchase of a watch,” and then returns a template answer “You have 1 year from the date of purchase to return the watch” associated with the matched question pattern to the user.

In another embodiment, machine learning allows for training of intent classification models. By providing the model a training set of a large number of examples and continually providing additional examples over time, the model will be able to pick up different patterns within the questions presented by a plurality of users over the course of time. One intent classification model that uses machine learning is the Naïve Bayes model. The Naïve Bayes model can be used for text classification and natural language processing. With respect to the Naives Bayes model, a set of questions are provided to the model and labeled as belonging to a particular class that represents an intent related to the set of questions. As new questions are received, each word within the question is counted for its occurrence and is scored as belonging to a particular class. The highest score for a particular class is determined. Based on the intent associated with the particular class with the highest score, an answer associated with the intent is provided to the user. For example, after analyzing the question “I want to return this watch,” it is determined that the question is related to a class associated with return policies for watches. The model may provide an answer that has been assigned to that particular class, such as “You have 1 year from the date of the purchase to return the watch.”

Although only two examples of classification methods are described, one skilled in the art would recognize any number and/or combination of classification methods can be used to generate a model that will determine the intent of a question posed by a user and return an answer to the question.

Although the consumer protection platform 320 example above employs an automated agent using machine learning, the consumer protection platform may employ a human agent or combination of a human agent and an automated agent to participate in the chat sessions.

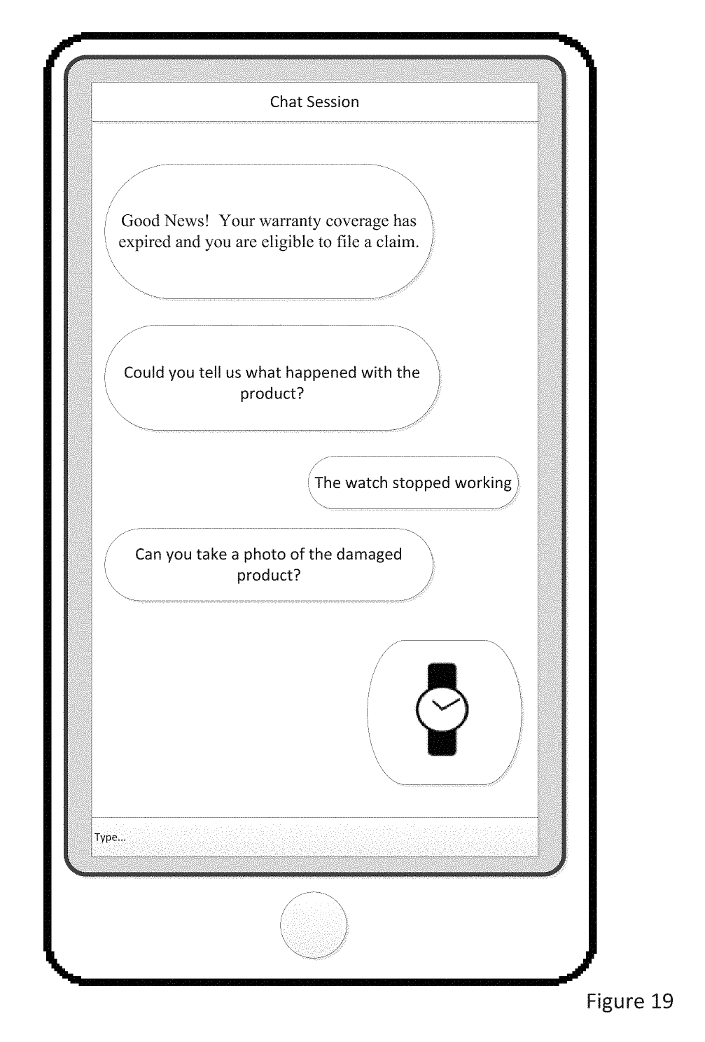

Additionally, the user may be able to transmit images of the product the user is inquiring about or sales receipts/bills/paperwork associated with the product via the chat session. For example, as illustrated in FIG. 19-21, the consumer protection platform 320 may receive an image of the product and/or sales receipts/bills/paperwork associated with the product. After receiving the images, the consumer protection platform 320 analyzes the image and extract information from the image. In another embodiment, the images may be saved and used to complete claim forms and/or may be attached to claim forms generated by the consumer protection platform 320.

The examples provided herein are non-exhaustive and many other examples of programming techniques and usage instances of the customer protection platform are within the scope and spirit of the disclosure.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A method for redeeming consumer protections, the method comprising:
retrieving item level purchase data for a purchase item from a user;
determining at least one policy that corresponds to the purchase item;
determining if the item level purchase data satisfies at least one predetermined condition associated with the determined policy when the at least one policy corresponds to the purchase item; and
generating a claim form when the item level purchase data satisfies the at least one predetermined condition associated with the determined policy.

2. The method of claim 1, further comprising
receiving user account information associated with at least one electronic address of the user;
accessing an electronic message server using the user account information;
monitoring electronic messages associated with the user on the electronic message server for the item level purchase data; and
extracting the item level purchase data.

3. The method of claim 1, further comprising:
receiving financial user account information associated with at least one of at least financial institution account of the user;
accessing the at least one financial institution account associated with the user using the received financial user account information;
monitoring transaction information associated with the financial institution account for item level purchase data;
extracting the item level purchase data from the transaction information.

4. The method of claim 3, further comprising:
generating a notification when the item level purchase data is extracted from the transaction information, the notification comprising a request for an electronic copy of a receipt associated with the item level purchase data.

5. The method of claim 1, wherein the item level purchase data includes an electronic copy of a receipt.

6. The method of claim 1, wherein the at least one policy that corresponds to the purchase item is associated with one of a retailer and a credit card associated with the user.

7. A system for redeeming consumer protections, the system comprising:
a processor-based application, which when executed on a computer, will cause the processor to:
retrieve item level purchase data for a purchase item from a user;
determine at least one policy that corresponds to the purchase item;
determine if the item level purchase data satisfies at least one predetermined condition associated with the determined policy when the at least one policy corresponds to the purchase item; and
generate a claim form when the item level purchase data satisfies the at least one predetermined condition associated with the determined policy.

8. The system of claim 1, further comprising
receive user account information associated with at least one electronic address of the user;
access an electronic message server using the user account information;
monitor electronic messages associated with the user on the electronic message server for the item level purchase data; and
extract the item level purchase data.

9. The system of claim 1, further comprising:
receive financial user account information associated with at least one of at least financial institution account of the user;
access the at least one financial institution account associated with the user using the received financial user account information;
monitor transaction information associated with the financial institution account for item level purchase data;
extract the item level purchase data from the transaction information.

10. The system of claim 3, further comprising:
generate a notification when the item level purchase data is extracted from the transaction information, the notification comprising a request for an electronic copy of a receipt associated with the item level purchase data.

11. The system of claim 1, wherein the item level purchase data includes an electronic copy of a receipt.

12. The system of claim 1, wherein the at least one policy that corresponds to the purchase item is associated with one of a retailer and a credit card associated with the user.

13. A non-transitory computer-readable storage medium encoded with executable instructions for redeeming consumer protections, wherein execution of the instructions by a processor cause the processor to:
retrieve item level purchase data for a purchase item from a user;
determine at least one policy that corresponds to the purchase item;
determine if the item level purchase data satisfies at least one predetermined condition associated with the determined policy when the at least one policy corresponds to the purchase item; and
generate a claim form when the item level purchase data satisfies the at least one predetermined condition associated with the determined policy.

14. The computer-readable medium of claim 1, further comprising
receive user account information associated with at least one electronic address of the user;
access an electronic message server using the user account information;
monitor electronic messages associated with the user on the electronic message server for the item level purchase data; and
extract the item level purchase data.

15. The computer-readable medium of claim 1, further comprising:
receive financial user account information associated with at least one of at least financial institution account of the user;
access the at least one financial institution account associated with the user using the received financial user account information;
monitor transaction information associated with the financial institution account for item level purchase data;
extract the item level purchase data from the transaction information.

16. The computer-readable medium of claim 3, further comprising:
generate a notification when the item level purchase data is extracted from the transaction information, the notification comprising a request for an electronic copy of a receipt associated with the item level purchase data.

17. The computer-readable medium of claim 1, wherein the item level purchase data includes an electronic copy of a receipt.

18. The computer-readable medium of claim 1, wherein the at least one policy that corresponds to the purchase item is associated with one of a retailer and a credit card associated with the user.
